(19) United States
(12) Patent Application Publication
(10) Pub. No.: US 2023/0204038 A1
(43) Pub. Date: Jun. 29, 2023

(54) STALL MARGIN IMPROVEMENT OF ROTOR FAN AND HOUSING FOR A VANEAXIAL BLOWER SYSTEM

(71) Applicant: Regal Beloit America, Inc., Beloit, WI (US)

(72) Inventors: Ramin Rezaei, Centerville, OH (US); Jacob Hansel, Fort Wayne, IN (US); SaiGeetha Padiri, Hyderabad (IN); Steven A. Trimble, Cassville, MO (US); Michael Herbert Braun, Fort Wayne, IN (US); Kevin Gerard Nowobilski, Fort Wayne, IN (US)

(21) Appl. No.: 18/146,124

(22) Filed: Dec. 23, 2022

Related U.S. Application Data
(60) Provisional application No. 63/388,696, filed on Jul. 13, 2022.

(30) Foreign Application Priority Data
Dec. 23, 2021 (IN) 202111060289

(51) Int. Cl. F04D 19/00; F04D 29/54; F24F 1/0029

(52) U.S. Cl. CPC F04D 19/002; F04D 29/544; F24F 1/0029; F05D 2260/961

(57) ABSTRACT

A vaneaxial blower system having a stator and a rotor is disclosed. Each of the stator and rotor have a hub and blades, each of the blades have a leading edge and a trailing edge, an angle theta defined by a line extending from the respective leading edges to the respective trailing edges and the respective hub and an angle beta defined as an angle measured between a camber line between a first blade and a second blade and a horizontal tangential line that extends through respective leading edges of the first and second blade.

### CROSS-REFERENCE TO RELATED APPLICATIONS

This application claims priority to Indian Provisional Application No. 202111060289 filed Dec. 23, 2021, titled Vaneaxial Blower System and to U.S. Provisional Application No. 63/388,696 filed Jul. 13, 2022, titled Stall Margin Improvement of Rotor Fan and Housing for a Vaneaxial Blower System; the contents of which are hereby expressly incorporated by reference in their entirety.

### TECHNICAL FIELD

The field of the disclosure relates generally to a vaneaxial blower system for indoor fluid moving applications.

### BACKGROUND OF INVENTION

Blowers are commonly used in the heating, ventilation, and air conditioning (HVAC) industries for moving indoor air. In a known blower, air is drawn into the indoor air moving system and then forced out an outlet into the indoor space. Known blowers include an impeller to move the air through the outlet into the indoor space. The efficiency of a blower when moving high-pressure air can be increased by using a vaneaxial fan, the vaneaxial fan improving the movement of air in the axial direction out the outlet via guide vanes.

Axial fans can experience stall conditions when the static pressure rise across fan blades reaches the fan operating static pressure developing limit, resulting in a reduction of flow velocity though the fan beyond a level at which the flow velocity initially falls to zero and subsequently reverses. As flow velocity reverses, it causes separation of air from the fan blades resulting in air turbulence with the separated air flow buffeting the fan blades. This aerodynamic instability induces stress within the blades that can result in mechanical failure of the fan motor, which otherwise requires balance across the fan blades to operate efficiently.

To mitigate stall conditions, axial fans are conventionally oversized relative to the required specifications of a given application, which is not economical. Alternatively, flow characteristics of the fan assembly, shroud assembly, fan shroud etc. can be optimized to improve airflow patterns within the fan. One such optimization can include fan blade shape. In particular, the shape and geometry of each blade, as well as the distance between blades can affect the static pressure profile of the axial fan and thus mitigate stalling conditions.

Therefore, there is a need in the art to provide vaneaxial blower systems that can improve laminar flow, improve the static pressure profile of the blower, and reduce turbulence of the fan blades.

### BRIEF DESCRIPTION

In one aspect, a vaneaxial blower system having an axis of rotation is disclosed. The vaneaxial blower system includes a stator shroud having a stator inlet and a stator outlet, and stator blades extending from a stator hub, the stator blades having a leading edge and a trailing edge; wherein an angle beta is defined as an angle measured between a camber line between a first stator blade and a second stator blade of the stator blades and a horizontal tangential line that extends through respective leading edges of the first stator blade and second stator blade; wherein an angle theta is defined by a line extending from the respective leading edges to the respective trailing edges and the stator hub. The vaneaxial blower system further includes a rotor fan having a hub, a rotor inlet and a rotor outlet, the rotor outlet positioned against the stator inlet; the rotor fan further comprising rotor blades having a leading edge and a trailing edge; wherein system airflow enters the rotor inlet and exits from the stator outlet. At a span at the stator hub, the angle beta for the leading edge is in the range of −3 degrees to −43 degrees and the angle beta for the trailing edge is in the range of 11 degrees to −29 degrees, the angle theta for the leading edge is 8 degrees to −32 degrees and the angle theta for the trailing edge is in the range of −7 degrees to −47 degrees. At a span at the stator shroud, the angle beta for the leading edge is in the range of −27 degrees to −67 degrees and the angle beta for the trailing edge is in the range of −2 degrees to −42 degrees, the angle theta for the leading edge is 8 degrees to −32 degrees and the angle theta for the trailing edge is in the range of −7 degrees to −47 degrees.

In another aspect, a vaneaxial blower system having an axis of rotation. The vaneaxial blower system includes a stator shroud having a stator inlet and a stator outlet, and stator blades extending from a stator hub, the stator blades having a leading edge and a trailing edge. The vaneaxial blower system further includes a rotor fan having a hub, a rotor inlet and a rotor outlet, the rotor outlet positioned against the stator inlet; the rotor fan further comprising rotor blades having a leading edge and a trailing edge; wherein system airflow enters the rotor inlet and exits from the stator outlet; wherein an angle beta is defined as an angle measured between a camber line between a first rotor blade and a second rotor blade of the rotor blades and a horizontal tangential line that extends through respective leading edges of the first rotor blade and second rotor blade; wherein an angle theta is defined by a line extending from the respective leading edges to the respective trailing edges and the hub of the rotor fan. At the rotor hub, the angle beta for the leading edge is in the range of 60 degrees to 100 degrees and the angle beta for the trailing edge is in the range of 20 degrees to 60 degrees, the angle theta for the leading edge is −43 degrees to −83 degrees and the angle theta for the trailing edge is in the range of −7 degrees to −47 degrees. At a span at the rotor hub, the angle beta for the leading edge is in the range of 57 degrees to 97 degrees and the angle beta for the trailing edge is in the range of 40 degrees to 80 degrees, the angle theta for the leading edge is −57 degrees to −97 degrees and the angle theta for the trailing edge is in the range of −25 degrees to −65 degrees.

In yet another aspect, a vaneaxial blower system having an axis of rotation. The vaneaxial blower system includes a stator shroud having a stator inlet and a stator outlet, and stator blades extending from a stator hub, the stator blades having a leading edge and a trailing edge; wherein an angle beta is defined as an angle measured between a camber line between a first stator blade and a second stator blade of the of the stator blades and a horizontal tangential line that extends through respective leading edges of the first stator blade and second stator blade; wherein an angle theta is defined by a line extending from the respective leading edges to the respective trailing edges and the stator hub. The vaneaxial blower system further includes a rotor fan having a hub, a rotor inlet and a rotor outlet, the rotor outlet positioned against the stator inlet; the rotor fan further comprising rotor blades having a leading edge and a trailing edge; wherein system airflow enters the rotor inlet and exits from the stator outlet; wherein an angle beta is defined as an angle measured between a camber line between a first rotor blade and a second rotor blade of the of the rotor blades and a horizontal tangential line that extends through respective leading edges of the first rotor blade and second rotor blade; wherein an angle theta is defined by a line extending from the respective leading edges to the respective trailing edges and the hub of the rotor fan. At a span at the stator hub, the angle beta for the leading edge is in the range of −3 degrees to −43 degrees and the angle beta for the trailing edge is in the range of 11 degrees to −29 degrees, the angle theta for the leading edge is 8 degrees to −32 degrees and the angle theta for the trailing edge is in the range of −7 degrees to −47 degrees; and, wherein at a span at the stator shroud, the angle beta for the leading edge is in the range of −27 degrees to −67 degrees and the angle beta for the trailing edge is in the range of −2 degrees to −42 degrees, the angle theta for the leading edge is 8 degrees to −32 degrees and the angle theta for the trailing edge is in the range of −7 degrees to −47 degrees. At a span at the rotor hub, the angle beta for the leading edge is in the range of 60 degrees to 100 degrees and the angle beta for the trailing edge is in the range of 20 degrees to 60 degrees, the angle theta for the leading edge is −43 degrees to −83 degrees and the angle theta for the trailing edge is in the range of −7 degrees to −47 degrees; and, wherein at the rotor hub, the angle beta for the leading edge is in the range of 57 degrees to 97 degrees and the angle beta for the trailing edge is in the range of 40 degrees to 80 degrees, the angle theta for the leading edge is −57 degrees to −97 degrees and the angle theta for the trailing edge is in the range of −25 degrees to −65 degrees.

These and other aspects and features of the present disclosure will be more readily understood when read in conjunction with the accompanying drawings.

### BRIEF DESCRIPTION OF THE DRAWINGS

FIG. 1 illustrates a cross-section view of an example vaneaxial blower system;

FIG. 2 illustrates a perspective view of an inlet director for use with the vaneaxial blower system shown in FIG. 1;

FIG. 3 illustrates a perspective view of the vaneaxial blower system with an embodiment of the inlet air flow director;

FIG. 4 illustrates an end view of a modular inlet flow director with the vaneaxial blower system;

FIG. 5 illustrates a perspective view of the inlet flow director shown in FIG. 3;

FIG. 6 illustrates a cross-sectional view near the inlet of the inlet flow director;

FIG. 7 illustrates a cross-sectional view near the height midpoint of the inlet flow director;

FIG. 8 illustrates a cross-sectional view near the outlet of the inlet flow director;

FIG. 9 illustrates a perspective view of the example vaneaxial blower system with one embodiment of a mounting plate;

FIG. 10 illustrates a cross-sectional view of the example vaneaxial blower system and mounting plate shown in FIG. 9;

FIG. 11 illustrates an enlarged cross-sectional view of the example vaneaxial blower system and mounting plate shown in FIG. 9;

FIG. 12 illustrates an enlarged cross-sectional view of the example vaneaxial blower system and mounting plate shown in FIG. 9;

FIG. 13 illustrates one embodiment of a mounting plate;

FIG. 14 illustrates another embodiment of a mounting plate;

FIG. 15 illustrates a perspective view of the mounting plate shown in FIG. 15 mounted to the vaneaxial blower system;

FIG. 16 illustrates a cross-sectional perspective view of the mounting plate shown in FIG. 15;

FIG. 17 illustrates a cross-sectional view of an example vaneaxial blower system with a supplemental fan;

FIG. 18 illustrates a cross-sectional view of an alternative vaneaxial blower system with a supplemental fan;

FIG. 19 illustrates a cross-sectional view of an example vaneaxial blower system with a cooling fin assembly;

FIG. 20 illustrates a cross-sectional view of an alternative embodiment of a vaneaxial blower system with a cooling fin assembly;

FIG. 21 illustrates a perspective cross-sectional view of an example vaneaxial blower system with an outlet ring cooling arrangement;

FIG. 22 illustrates an example rotor fan having airflow openings defined therein;

FIG. 23 illustrates an example stator having airflow openings defined therein;

FIG. 24 illustrates an alternative stator having airflow openings defined therein;

FIG. 25 illustrates an embodiment of the vaneaxial blower system with a connected control assembly;

FIG. 26 illustrates a perspective cross-sectional view of the vaneaxial blower system shown in FIG. 25;

FIG. 27 illustrates a perspective view of the vaneaxial blower system shown in FIG. 25;

FIG. 28 illustrates an enlarged cross-sectional view of the vaneaxial blower system, taken within Area 21 shown in FIG. 25;

FIG. 29 illustrates a cross-sectional view of an example vaneaxial blower system;

FIG. 30 is an enlarged cross-sectional view of the vaneaxial blower system, taken within Area 24 shown in FIG. 29;

FIG. 31 is an enlarged cross-sectional view of the vaneaxial blower system, taken within Area 26 shown in FIG. 29;

FIG. 32 is an enlarged cross-sectional view of the vaneaxial blower system, taken within Area 25 shown in FIG. 29;

FIG. 33 is an enlarged cross-sectional view of the vaneaxial blower system, taken within Area 26 shown in FIG. 29;

FIG. 34 is an enlarged cross-sectional view of the vaneaxial blower system, taken within Area 27 shown in FIG. 29;

FIG. 35 is an enlarged cross-sectional view of the vaneaxial blower system, taken within Area 28 shown in FIG. 29;

FIG. 36 is an enlarged cross-sectional view of the vaneaxial blower system, taken within Area 29 shown in FIG. 29;

FIG. 37 is an enlarged cross-sectional view of the vaneaxial blower system, taken within Area 29 shown in FIG. 29;

FIG. 38 is an enlarged cross-sectional view of the vaneaxial blower system, taken within Area 29 shown in FIG. 29;

FIG. 39 is an enlarged cross-sectional view of the vaneaxial blower system, taken within Area 30 shown in FIG. 29;

FIG. 40 illustrates an axial view of an example rotor of the vaneaxial blower system;

FIG. 41 illustrates an enlarged view of the rotor shown in FIG. 40;

FIG. 42 illustrates an axial view of an example rotor of the vaneaxial blower system;

FIG. 43 illustrates an enlarged view of the rotor shown in FIG. 42.

FIG. 44 illustrates an axial view of an example rotor of the vaneaxial blower system;

FIG. 45 illustrates an enlarged view of the rotor shown in FIG. 44;

FIG. 46 illustrates an axial view of an example rotor of the vaneaxial blower system;

FIG. 47 illustrates an enlarged view of the rotor shown in FIG. 46;

FIG. 48 illustrates an enlarged view of the rotor shown in FIG. 46;

FIG. 49 illustrates an enlarged view of the rotor shown in FIG. 46;

FIG. 50 illustrates a perspective view of an example rotor of the vaneaxial blower system;

FIG. 51 illustrates an enlarged view of the rotor shown in FIG. 50;

FIG. 52 illustrates an enlarged view of the rotor shown in FIG. 50;

FIG. 53 is an enlarged cross-sectional view of the vaneaxial blower system, taken within Area 29 shown in FIG. 29;

FIG. 54 is a cross-sectional view of the example vaneaxial blower assembly;

FIG. 55 is a schematic diagram of rotor blade and stator blade angles of the example vaneaxial blower assembly;

FIG. 56 is a table of example rotor blade angles at various points along the rotor blade span;

FIG. 57 is a table of example stator blade angles at various points along the stator blade span;

FIG. 58 is a cross-sectional view of a rotor blade at span 0 proximate the rotor hub;

FIG. 59 is a graph of the theta angle and the beta angle from the leading edge to the trailing edge of a rotor blade at span 0;

FIG. 60 is a cross-sectional view of a rotor blade at span 0.5 between the rotor hub and the rotor shroud;

FIG. 61 is a graph of the theta angle and the beta angle from the leading edge to the trailing edge of a rotor blade at span 0.5;

FIG. 62 is a cross-sectional view of a rotor blade at span 1 proximate the rotor shroud;

FIG. 63 is a graph of the theta angle and the beta angle from the leading edge to the trailing edge of a rotor blade at span 1;

FIG. 64 is a cross-sectional view of a stator blade at span 0 proximate the stator hub;

FIG. 65 is a graph of the theta angle and the beta angle from the leading edge to the trailing edge of a stator blade at span 0;

FIG. 66 is a cross-sectional view of a stator blade at span 0.5 between the stator hub and the stator shroud;

FIG. 67 is a graph of the theta angle and the beta angle from the leading edge to the trailing edge of a stator blade at span 0.5;

FIG. 68 is a cross-sectional view of a stator blade at span 1 proximate the stator shroud;

FIG. 69 is a graph of the theta angle and the beta angle from the leading edge to the trailing edge of a stator blade at span 1;

FIG. 70 illustrates the example vaneaxial blower system including an outlet diffuser;

FIG. 71 illustrates the outlet diffuser having a plurality of perforations;

FIG. 72 illustrates the example vaneaxial blower system coupled to the surrounding air moving system using a suspension system;

FIG. 73 illustrates the example vaneaxial blower system coupled to the surrounding air moving system using a dampening system;

FIG. 74 is an enlarged view of the dampening system shown in FIG. 73;

FIG. 75 illustrates an example vaneaxial blower system having a unitary body;

FIG. 76 illustrates the example vaneaxial blower system as a retrofit package;

FIG. 77 illustrates one embodiment of the vaneaxial blower assembly with a remote control assembly;

FIG. 78 illustrates another embodiment of the vaneaxial blower assembly with a remote control assembly;

FIG. 79 illustrates a perspective partial cutaway view of an example blower and control system within an air moving system;

FIG. 80 illustrates a top view of the system shown in FIG. 79;

FIG. 81 illustrates a perspective partial cutaway view of an alternative blower and control system within an air moving system;

FIG. 82 illustrates the vaneaxial blower system with the control assembly coupled to the stator;

FIG. 83 illustrates a vector plot and flow simulation of airflow through rotor blades and stator blades of the vaneaxial blower assembly.

FIG. 84 illustrates a contour plot and flow simulation of airflow through rotor blades and stator blades of the vaneaxial blower assembly.

The reference symbols used in the drawings, and their meanings, are listed in summary form in the list of reference symbols. In principle, identical parts are provided with the same reference symbols in the figures.

### DETAILED DESCRIPTION

In the following specification and the claims, reference will be made to a number of terms, which shall be defined to have the following meanings.

As used herein, the spatial terms “upper,” “lower,” “top” and “bottom” as used in the present disclosure shall denote a component, or an element of a component, which is upstream or downstream relative to other components and elements of components unless the context clearly dictates otherwise. The term “upper” or “top” shall denote a downstream component or element of a component, and the term “lower” or “bottom” shall denote an upstream component or element of a component. Where a component has a top surface and a bottom surface, the top surface is parallel to the bottom surface. Such relative spatial terms are used only to facilitate description and are not meant to be limiting.

The embodiments described herein relate to a vaneaxial blower system. More specifically, embodiments relate to a vaneaxial blower system including an inlet air flow director, a stall margin improvement system, a motor cooling system, a motor mounting system, at least one stator blade, and at least one rotor blade. Additional embodiments can include a retrofit system package and reduced sound output.

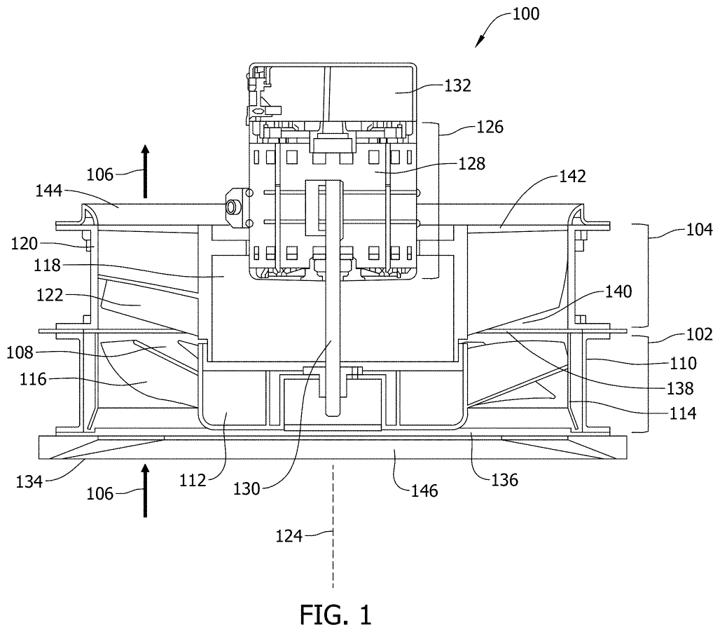

FIG. 1 illustrates an example embodiment of a vaneaxial blower system 100. Vaneaxial blower system 100 includes a rotor 102 and a stator 104 positioned downstream from rotor 102, as defined by the direction of airflow 106 channeled through vaneaxial blower system 100. Rotor 102 includes a rotor fan 108 and a rotor housing 110 extending around rotor fan 108. Rotor fan 108 includes a rotor hub 112, a rotor shroud 114, and a plurality of rotor blades 116 arranged circumferentially about rotor hub 112 and extending between rotor hub 112 and rotor shroud 114. Stator 104 includes a stator hub 118, a stator shroud 120, and a plurality of stator blades 122 extending therebetween. In operation, and as will be described in more detail below, airflow 106 enters the rotor housing and is then discharged from rotor 102 towards stator 104. Rotor blades 116 are oriented such that airflow 106 discharged from rotor 102 has a directional component that is generally non-linear relative to centerline 124. Thus, stator blades 122 are oriented to straighten airflow 106 that flows to the stator from rotor 102, and discharge airflow 106 from stator 104 that is generally longitudinally aligned with centerline 124.

Vaneaxial blower system 100 further includes a motor 126 coupled to rotor 102. Specifically, motor 126 includes a motor casing 128 and a motor shaft 130 extending therefrom. In the illustrated embodiment, motor 126 is coupled within vaneaxial blower system 100 by mounting motor casing 128 to stator 104, as will be described in more detail below. Motor shaft 130 extends from motor casing 128 for coupling to rotor 102. Thus, rotation of rotor 102 is enabled by the actuation of motor 126 and the resulting rotation of motor shaft 130.

Airflow 106 enters vaneaxial blower system 100 via blower system inlet 134 and travels toward rotor 102. Rotor 102 includes a rotor inlet 136 and a rotor outlet 138. Rotor inlet 136 is positioned in downstream communication from the blower system inlet area, rotor inlet 136 defining a rotor inlet area. Airflow 106 enters rotor 102 via the rotor inlet area and travels through rotor 102, in the direction of stator 104. Stator 104 includes a stator inlet 140 and a stator outlet 142. Stator inlet 140 is positioned in downstream communication from rotor outlet 138, stator inlet 140 defining a stator inlet area. Airflow 106 enters stator 104 via the stator inlet area and travels through stator 104, in the direction of a blower system outlet 144. Blower system outlet 144 is positioned in downstream communication from stator outlet 142, blower system outlet 144 defining a blower system outlet area. Airflow 106 is discharged from vaneaxial blower system 100 via the blower system outlet area, airflow 106 moved through vaneaxial blower system 100 by motor 126 and control assembly 132.

In some embodiments, the vaneaxial blower system 100 includes an inlet air flow director 146 coupled to rotor 102 and positioned upstream of rotor inlet 136 (as best shown in FIG. 3). In at least some embodiments, vaneaxial blower system 100 is positioned within an air moving system 148 (as best shown in FIG. 3) that can have a square, circular, or other suitable geometric cross-sectional shape. The inlet air flow director 146 is shaped to direct substantially all of airflow 106 channeled through the duct into rotor inlet 136 of vaneaxial blower system 100.

The inlet air flow director 146 can be secured within air moving system using any mechanism and/or fastening system that enables vaneaxial blower system 100 to function as described herein. In some embodiments, inlet air flow director 146 can be connected to rotor housing 110 of rotor 102 with fasteners, or via interlocking features defined on rotor 102 and inlet air flow director 146. In other embodiments, inlet air flow director 146 can be connected to rotor fan 108. The connection between inlet air flow director 146 and rotor 102 reduces the amount of airflow 106 allowed to bypass rotor inlet 136, thereby promoting laminar air flow.

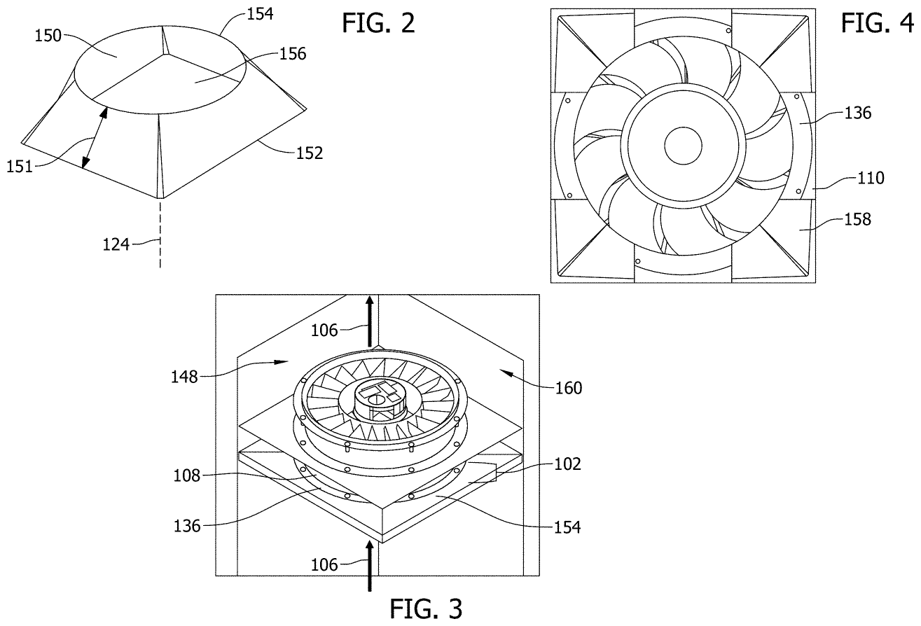

Referring to FIG. 2, inlet air flow director 146 includes a plurality of sidewalls 150 oriented obliquely relative to each other to define an inlet air flow director inlet 152, an inlet air flow director outlet 154, and an interior flow channel 156 extending therebetween. Inlet air flow director outlet 154 has a smaller cross-sectional area than inlet air flow director inlet 152. Inlet air flow director inlet 152 directs airflow 106 into vaneaxial blower system 100 and reduces the turbulence of airflow 106.

Inlet air flow director inlet 152 and inlet air flow director outlet 154 may have any cross-sectional shape that enables vaneaxial blower system 100 to function as described herein. In the example embodiment, inlet air flow director inlet 152 has a rectangular cross section and inlet air flow director outlet 154 has a circular cross section. Inlet air flow director inlet 152 and inlet air flow director outlet 154 are connected by a plurality of sidewalls 150 of the air flow director 146, the sidewalls 150 oriented at an angle from centerline 124 to promote laminar flow and minimize air turbulence. Inlet air flow director inlet 152 has a rectangular cross section to prevent air flow from circumventing the rectangular cross section of blower system inlet 134 (as best shown in FIG. 1). Inlet air flow director outlet 154 has a circular cross section to align with the circular cross section of rotor inlet 136 in downstream communication from inlet air flow director outlet 154 (as best shown in FIG. 3). The length of sidewalls 150 may be of a sidewall length dimension 151 to reduce the amount of space between blower system inlet 134 and rotor inlet 136. In one embodiment, the sidewall length dimension 151 allows for the sidewalls 150 to extend from the coil to the rotor inlet 136. In some embodiments, sidewalls 150 may be textured to reduce noise and provide directionality to airflow 106. The texture of sidewalls 150 may include smooth, ribbed, wavy, and/or perforated textures.

Perforated texturing reduces drag and reduces noise of the vaneaxial blower system 100, which allow for more aggressive expansion angles with less turbulence. Less turbulence decreases static pressure, watts, and noise. Furthermore, research has shown that perforated holes in the sheet metal can be sized and configured to create the same effect as perforated texturing. Perforated hole sizes are designed and configured for optimal sound absorption and turbulence reduction.

FIG. 3 illustrates a perspective view of vaneaxial blower system 100 with an embodiment of inlet air flow director 146. Rotor 102 is positioned downstream from inlet air flow director 146. Inlet air flow director outlet 154 has a circular cross section that generally aligns with the circular cross section of rotor inlet 136. Inlet air flow director 146 may be secured within air moving system 148 using any mechanism and/or fastening system that enables vaneaxial blower system 100 to function as described herein. In some embodiments, inlet air flow director 146 may be connected to rotor housing 110 of rotor 102 with fasteners, or via interlocking features defined on rotor 102 and inlet air flow director 146. In other embodiments, inlet air flow director 146 may be connected to rotor fan 108. The connection between inlet air flow director 146 and rotor 102 reduces the amount of airflow 106 allowed to bypass rotor inlet 136, thereby promoting laminar air flow.

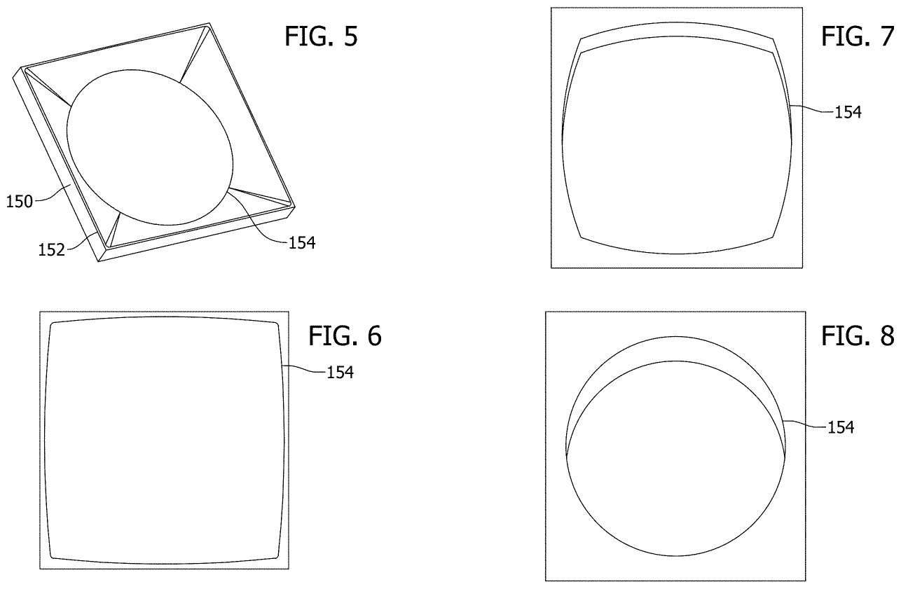

Referring to FIG. 4, in some embodiments, inlet air flow director 146 is formed from a plurality of modular sections 158 shaped to be abutted against the corners defined by adjoining air moving system walls 160 of air moving system 148. Modular sections 158 reduce the amount of material required for manufacturing and also allow for increased production volume. Modular sections 158 can also be used as a retrofit on any type of air moving unit, and can also be used at the outlet of stator 104. The exact sizing of the modular sections 158 is optimized such that a single design can be used in all or multiple duct or cabinet sizes and also with the least amount of material or cost. In some embodiments, modular sections 158 may form slight gaps to the unit ducting. Furthermore, in some embodiments, modular sections 158 may be solid or hollow and formed from any combination of plastic or metal. Modular sections 158 may be manufactured a single integral piece, or may be made up of multiple pieces coupled together. Corner parts or duct sides of the modular sections 158 may be formed from a flexible material and extend out further to flare out to seal in larger units and slide up into the ducting in smaller small unit ducts. Modular sections 158 may snap into place on blower system inlet 134 or onto the rotor housing 110 generally and be adjustable to various locations to match set standard duct sizes.

FIG. 5-8 are perspective views of inlet air flow director 146. FIG. 5 is a perspective top view of inlet air flow director 146. FIG. 6-8 are cross-sectional views of inlet air flow director 146 at various locations along the airstream, illustrating the transition in geometry from the inlet air flow director inlet 152 to the inlet air flow director outlet 154.

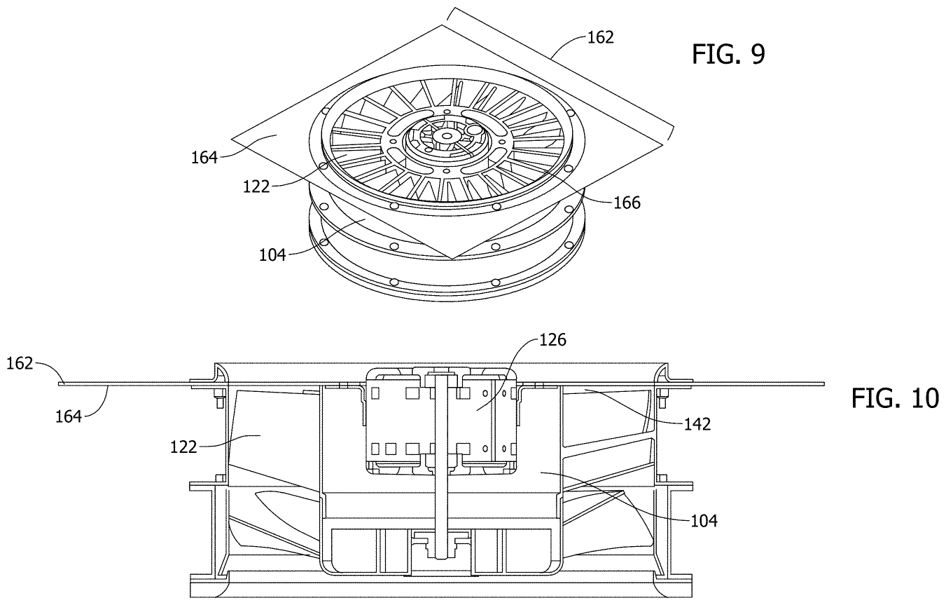

FIGS. 9-12 are various views of vaneaxial blower system 100 with a motor mounting system coupled to stator 104. In the example embodiment, motor mounting system includes a mounting plate 162 having a main body section 164 and an inner hub section 166 having a circular cross section. Main body section 164 has a greater cross-sectional area than inner hub section 166. Mounting plate 162 is coupled to rotor 102 and/or stator 104 and is used to mount motor 126 to rotor 102 and/or stator 104, in order to maintain structural integrity and reduce airflow 106 turbulence. Motor 126 may be a radial motor and/or an axial motor, or even an external rotor motor.

Referring to FIG. 9, motor mounting system is coupled to stator 104, mounting plate 162 positioned downstream from stator outlet 142. Stator outlet 142 has a circular cross section adapted to align with the cross-sectional area of inner hub section 166. Thus, airflow 106 obstruction therebetween is reduced.

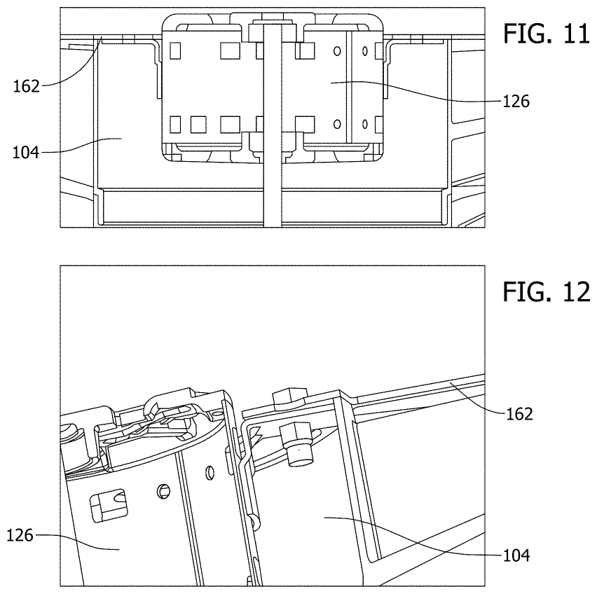

As illustrated in FIG. 10, motor 126 may be mounted directly to mounting plate 162 to reduce the stress on stator 104. FIG. 11 is an enlarged view of the FIG. 10 side perspective of vaneaxial blower system 100 with motor mounting system coupled to stator 104. FIG. 12 is an enlarged perspective of FIG. 11, illustrating one type of connection of mounting plate 162 to motor 126 above stator 104. In some embodiments, mounting plate 162 is connected to motor 126 through rigid mounting lugs attached to motor 126, the rigid mounting lugs connecting mounting plate 162 to motor casing 128 with a metal bracket, the metal bracket stamped at a right angle. In other embodiments, stator hub 118 acts as the housing around motor 126.

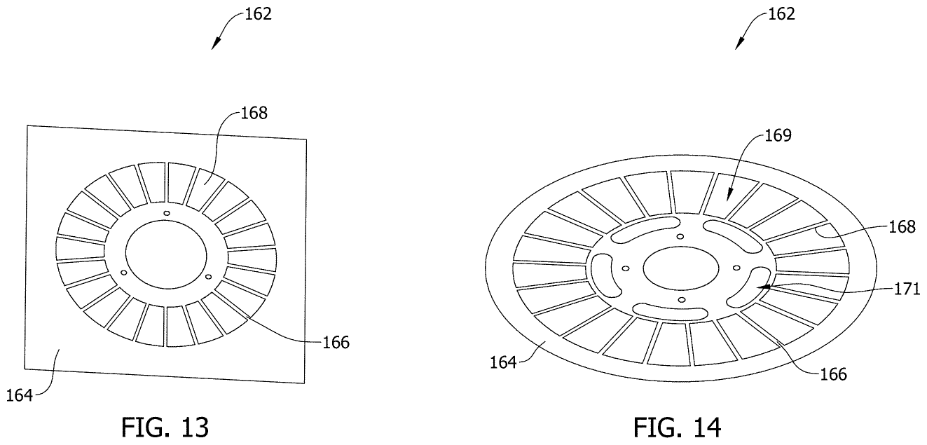

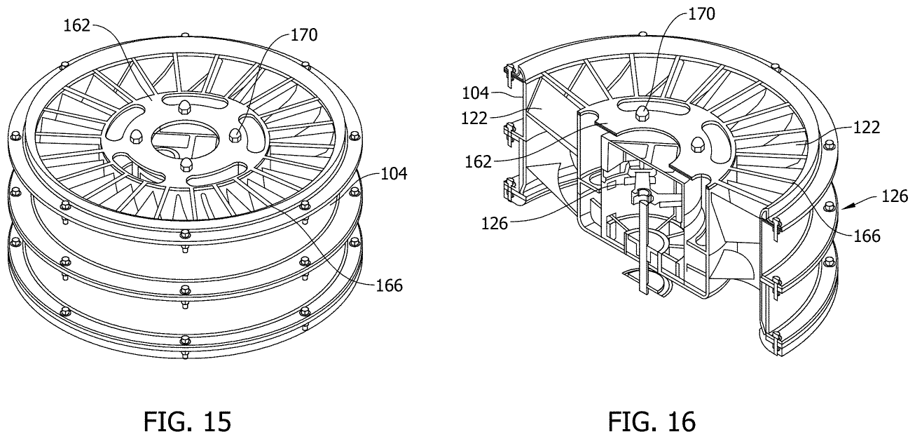

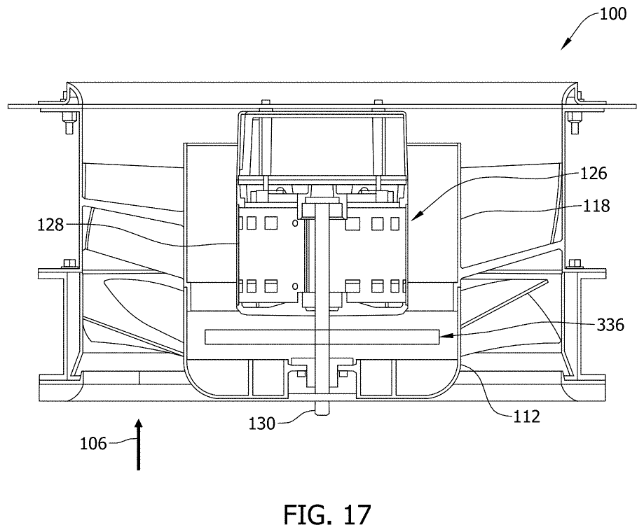

As shown in FIGS. 13-16, the inner hub section 166 of the mounting plate 162 may have a plurality of spokes 168 extending therebetween. The plurality of spokes 168 are positioned to align with the trailing edge of stator blades 122 to avoid airflow 106 obstruction. Airflow gaps 169 are defined between spokes, and a width of the spokes 168 are substantially less than a width of the gaps 169 to enhance the amount of airflow 106 through inner hub section 166. In some embodiments, inner hub section 166 may have a plurality of spokes 168 and annular rings 171, which both enhance the amount of airflow 106 through inner hub section 166. In other embodiments, inner hub section 166 may have openings with an ellipses cross section to increase circulation of airflow 106 inside stator hub 118 to cool motor 126. As shown in FIGS. 15 and 16, in some embodiments, mounting plate 162 may be coupled to motor 126 by mounting holes 170 in inner hub section 166. (FIGS. 16-17). As best shown in FIG. 17, the spokes 168 of the mounting plate 162 are substantially aligned with the stator blades 122 of the stator 104.

FIGS. 17-24 illustrate embodiments of vaneaxial blower system 100 with enhanced motor cooling capabilities (also reffered to as a motor cooling system). Effective cooling of motor 126, and any associated control assembly, increases the efficiency and lifespan of vaneaxial blower system 100. One or more motor cooling mechanisms, as described below, may be included in vaneaxial blower system 100 to facilitate the motor cooling described herein.

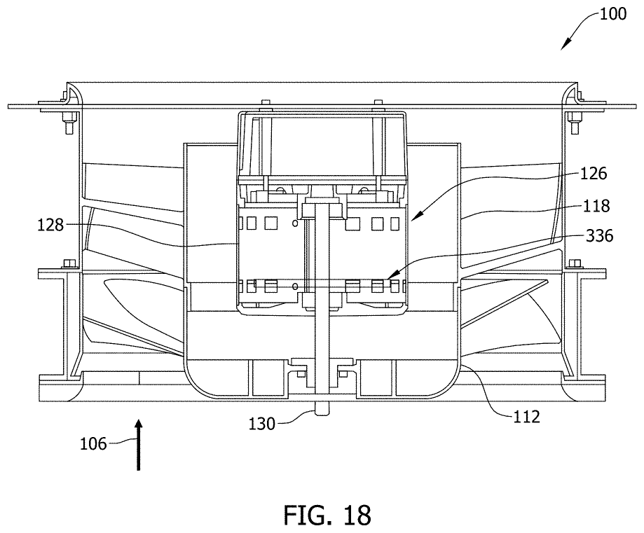

Referring to FIGS. 17 and 18, vaneaxial blower system 100 includes a supplemental fan 336 coupled to motor shaft 130, such as with a set screw or with a press fit. Supplemental fan 336 may be positioned externally of motor casing 128 (as best shown in FIG. 17), and/or internally of motor casing (as best shown in FIG. 18). In addition, supplemental fan 336 is radially undersized relative to rotor hub 112 and stator hub 118. Thus, airflow 106, generated by rotation of motor shaft 130 that actuates supplemental fan 336, is directed towards motor 126 for cooling thereof.

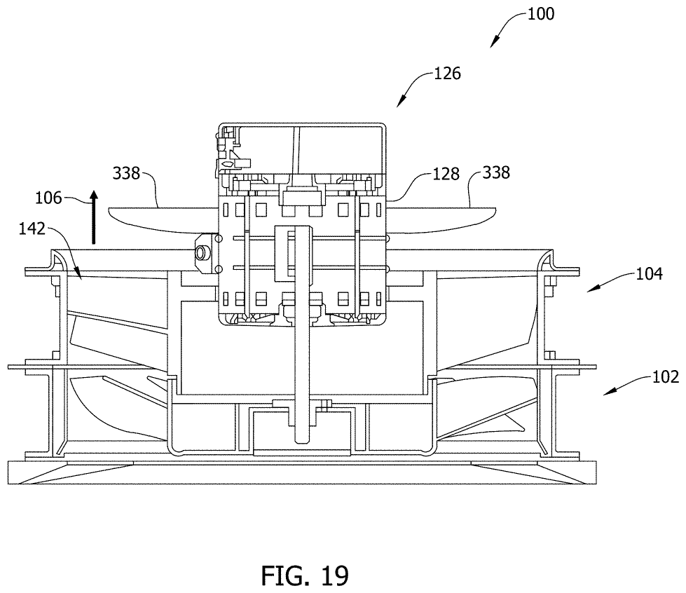

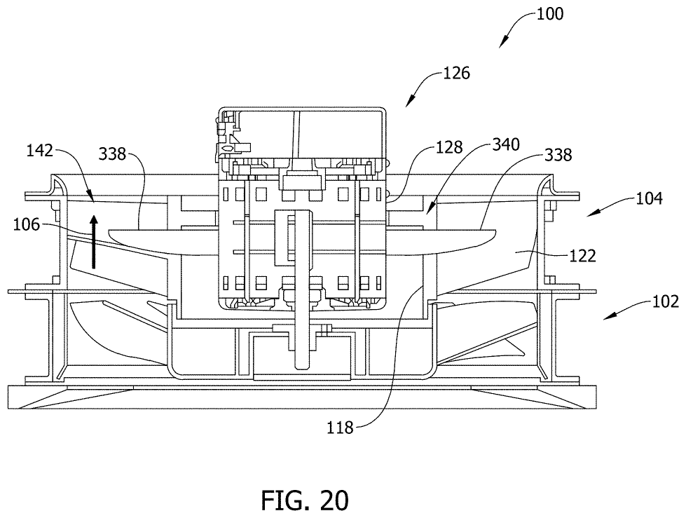

Referring to FIGS. 19 and 20, the vaneaxial blower system 100 includes a plurality of cooling fins 338 coupled to motor casing 128, and arranged at circumferential intervals thereabout. Cooling fins 338 extend radially from motor casing 128 to be positioned within airflow 106 discharged from stator outlet 142. Thus, cooling fins 338 are fabricated from any thermally conductive material that enables vaneaxial blower system 100 to function as described herein. Thus, heat generated by motor 126 may be dissipated to airflow 106 by cooling fins 338.

Referring to FIG. 19, cooling fins 338 positioned downstream of stator 104 to enable contact to be made with airflow 106 discharged from stator 104. Alternatively, referring to FIG. 20, a fin slot 340, associated with a respective cooling fins 338, may be defined in stator hub 118. Fin slots 340 are defined between adjacent stator blades 122 to avoid interfering with the alignment thereof. Each cooling fin 338 may be sized for insertion within a respective fin slot 340 to enable motor 126 to be positioned further within stator hub 118, than as illustrated in FIG. 19.

Any number of cooling fins 338 may be arranged about motor casing 128 that enables vaneaxial blower system 100 to function as described herein. In addition, cooling fins 338 have any geometry that enables vaneaxial blower system 100 to function as described herein. For example, cooling fins 338 may be shaped to maintain the directionality of airflow 106 discharged from stator 104. Cooling fins 338 may also be shaped to act as a supplemental flow straightener.

Cooling fins 338 may be coupled to motor casing 128 by hooking or snapping them in place into the motor shell vent hole slots to allow for ease of assembly. Cooling fins 338 may also be welded to motor casing 128 to enhance heat transfer therebetween. Cooling fins 338 could then be used as a mounting feature for motor 126. In addition, stator 104 may be fabricated from metal, such that when attached to motor 126, stator 104 acts as a fin to cool motor 126 and the control assembly.

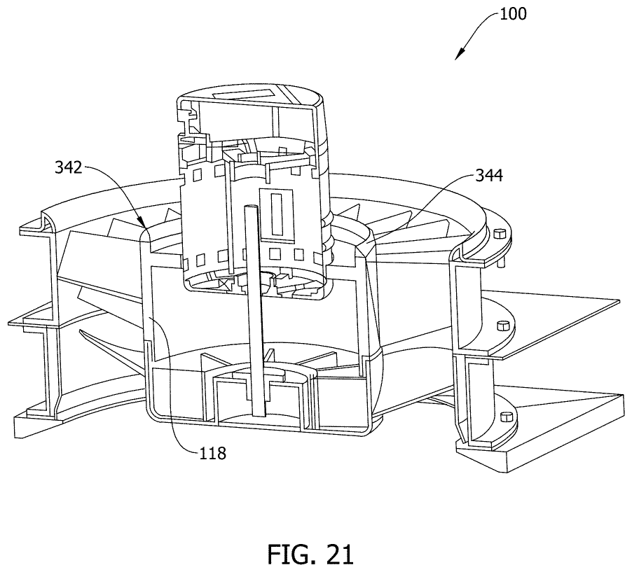

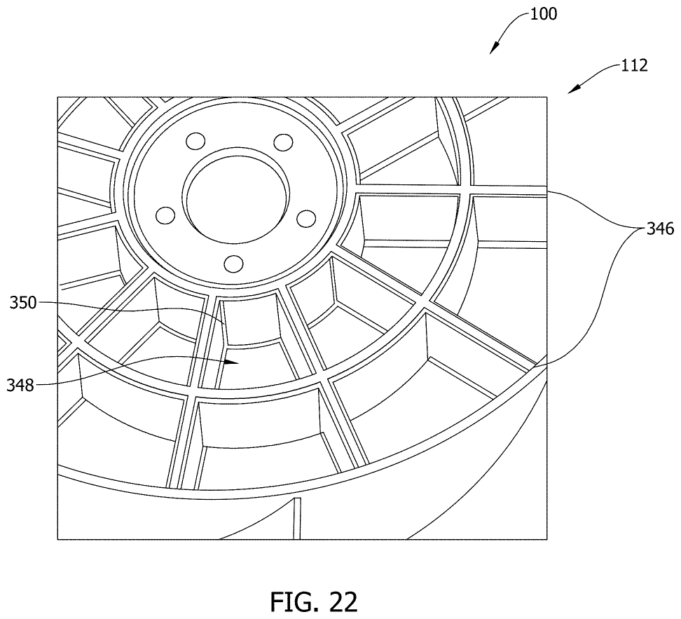

Referring to FIG. 21, vaneaxial blower system 100 includes a second outlet ring 342 coupled to stator hub 118. Second outlet ring 342 has a flow surface 344 that is concave relative to the centerline of vaneaxial blower system 100. Thus, airflow 106 discharged from stator 104 is directed across flow surface 344 and towards motor 126 to facilitate cooling thereof, and/or of the control assembly.

Referring to FIGS. 22-24, vaneaxial blower system 100 is cooled by defining an airflow channel through rotor hub 112 and stator hub 118. For example, referring to FIG. 22, rotor hub 112 includes structural ribbing 346 extending both radially and circumferentially relative to the centerline of vaneaxial blower system 100. In the example embodiment, airflow openings 348 are defined in at least some of the spaces between adjacent structural ribbing 346, thereby enabling airflow to be channeled through rotor hub 112 and towards stator 104. In addition, an airflow vane 350 may be defined within airflow openings 348 such that airflow discharged from rotor outlet may be directed in a desired orientation.

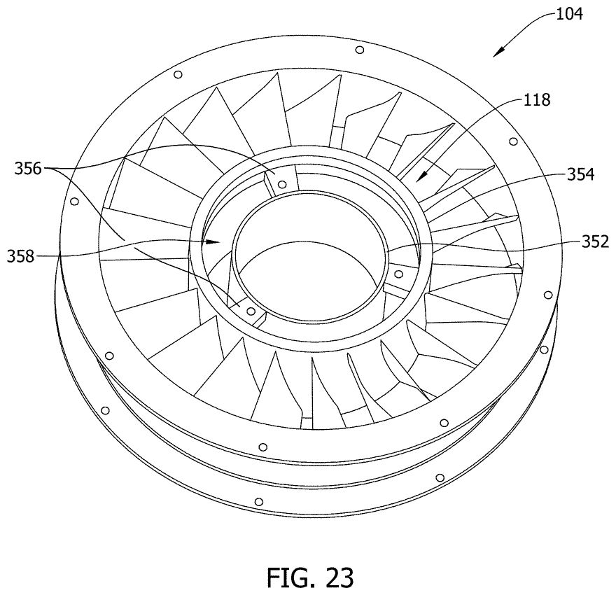

Referring to FIG. 23, stator hub 118 includes an inner ring 352, an outer ring 354, and a plurality of spokes 356 extending radially therebetween. Thus, circumferential gaps in mounting plate 358 defined between adjacent spokes 356 enables airflow to be channeled therethrough. Inner ring 352 may also be used as a mounting point for motor 126. For example, motor 126 may be press fit (as a whole motor or using stator hub 118 as a shell) into stator hub 118 such that stator hub 118 acts as a heat sink that is subject to convection of the airflow channeled through stator 104. Thus, inner ring 352 and spokes 356 may be fabricated from any suitable thermally conductive material, such as a metallic material (e.g., aluminum). In addition, motor 126 may be mounted inside stator hub 118, and any gap therebetween filled with a thermal grease or foam to facilitate conducting heat from motor 126.

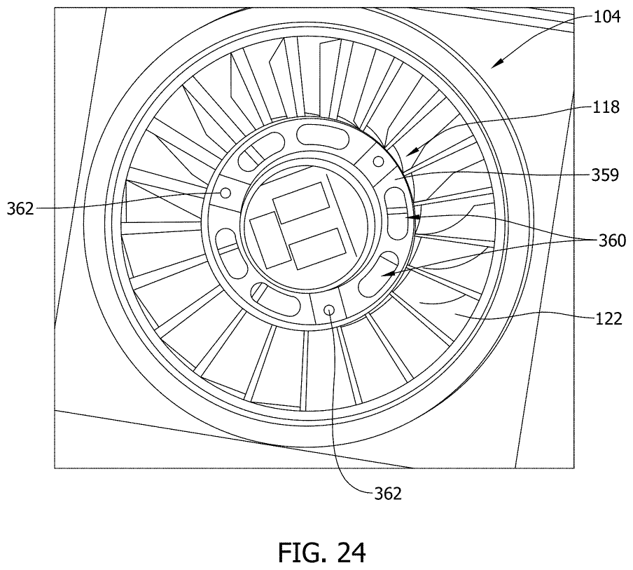

Alternatively, referring to FIG. 24, stator hub 118 includes a mounting surface 359 having airflow openings 360 and mounting lugs 362 included thereon. Mounting lugs 362 provide a fastening location for coupling motor 126 to stator hub 118. Airflow openings 360 extend between adjacent mounting lugs 362, and enable airflow to be channeled therethrough. The airflow channeled through airflow openings 360, and then discharged from stator 104, is radially inward of the main airflow discharged from stator blades 122. Thus, this cooling airflow is channeled past motor 126 to facilitate cooling thereof.

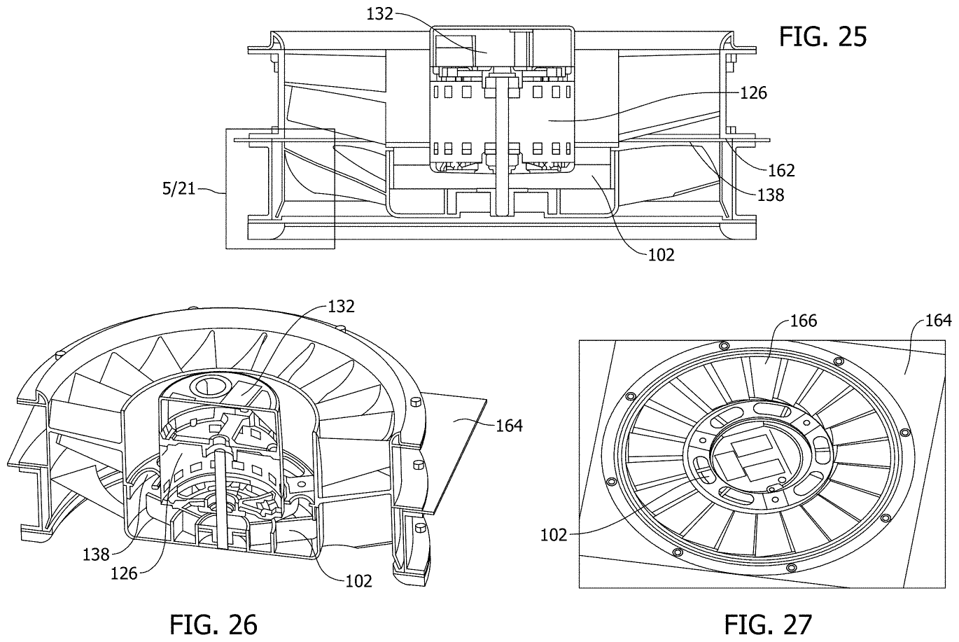

FIGS. 25 through 27 are various views of vaneaxial blower system 100 with motor mounting system coupled to stator 104. FIG. 25 is a side view of vaneaxial blower system 100 with motor mounting system coupled to stator 104, and a mounting plate 162 positioned downstream from rotor outlet 138. FIG. 26 is a side perspective of the FIG. 25 side view of vaneaxial blower system 100 with motor mounting system coupled to stator 104. FIG. 27 is a top view of vaneaxial blower system 100 with motor mounting system coupled to stator 104. Rotor outlet 138 has a circular cross section adapted to align with the cross-sectional area of inner hub section 166, minimizing air flow obstruction. The coupling of vaneaxial blower system 100 motor mounting system and stator 104 allows for control assembly 132 to be mounted integral to the motor 126.

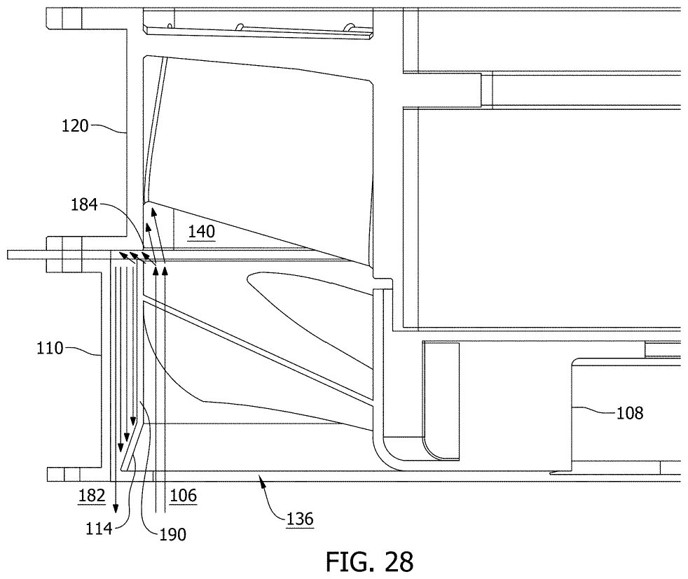

FIGS. 28 through 39 illustrate embodiments of vaneaxial blower system 100 with improved stall margin capabilities. The improved stall margin capabilities, and higher static pressure stall point, is achieved by reducing air recirculation between rotor shroud 114 and rotor housing 110. As shown in FIG. 28, as the rotor fan 108 rotates and air (airflow 106) is urged through the vaneaxial blower system 100, recirculated air 182 escapes between an inner edge 184 of the stator inlet 140 and an outer surface 190 of the rotor shroud 114. The recirculated air 182 is urged out from the rotor inlet 136 in a direction that is opposite the airflow 106. The recirculated air 182 reduces the static pressure of the vaneaxial blower system 100 and reduces the efficiency of the system generally. One or more recirculation inhibitors, as described below, can be included in vaneaxial blower system 100 to facilitate reducing the air recirculation. As explained in further detail below, the embodiments of the one or more recirculation inhibitors can be combined to yield a reduction in the air recirculation.

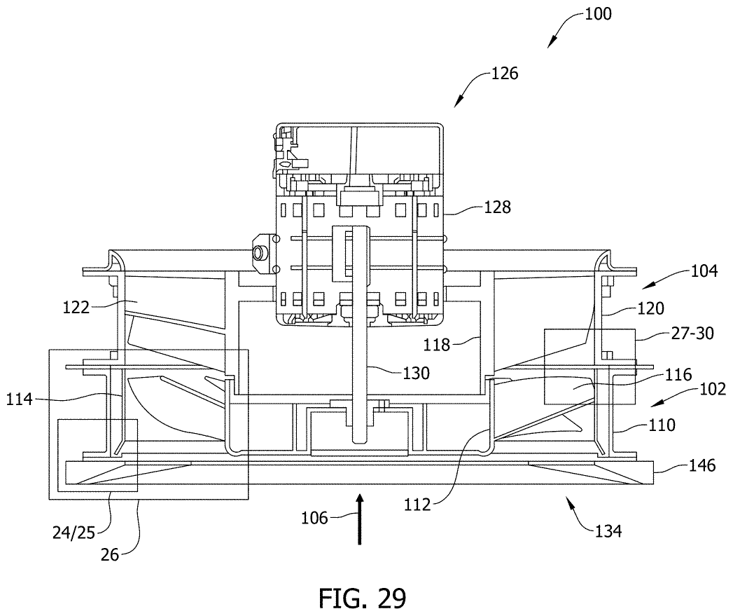

Referring to FIGS. 29 through 31, vaneaxial blower system 100 includes an inlet casing 300 coupled between rotor housing 110 and inlet air flow director 146. Inlet casing 300 includes a main body portion 302 positioned between rotor housing 110 and inlet air flow director 146, and a lip section 304 oriented obliquely and/or perpendicularly relative to main body portion 302. Lip section 304 extends circumferentially and defines a central opening 306 of inlet casing 300. Central opening 306 further defines blower system inlet 134.

In addition, in the example embodiment, rotor shroud 114 includes a first rim 308 defining rotor inlet 136. Rotor shroud 114 further includes a flared inlet section 310 extending from first rim 308, and a main body section 312 extending from flared inlet section 310. The combination of lip section 304 and flared inlet section 310 define the recirculation inhibitor 314 for restricting airflow recirculation through a recirculation chamber 316 between rotor shroud 114 and rotor housing 110, towards blower system inlet 134. For example, flared inlet section 310 extends between rotor housing 110 and lip section 304 to define a first restrictor gap 318 between rotor housing 110 and flared inlet section 310, and a second restrictor gap 320 between flared inlet section 310 and lip section 304. Thus, restrictor gaps 318 and 320 are sized to facilitate creating a bottle neck, which restricts airflow 106 between recirculation chamber 316 and blower system inlet 134.

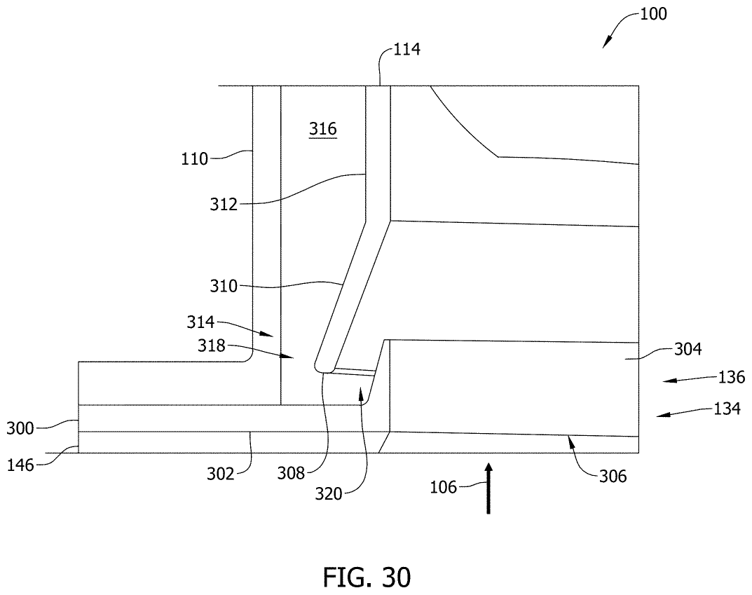

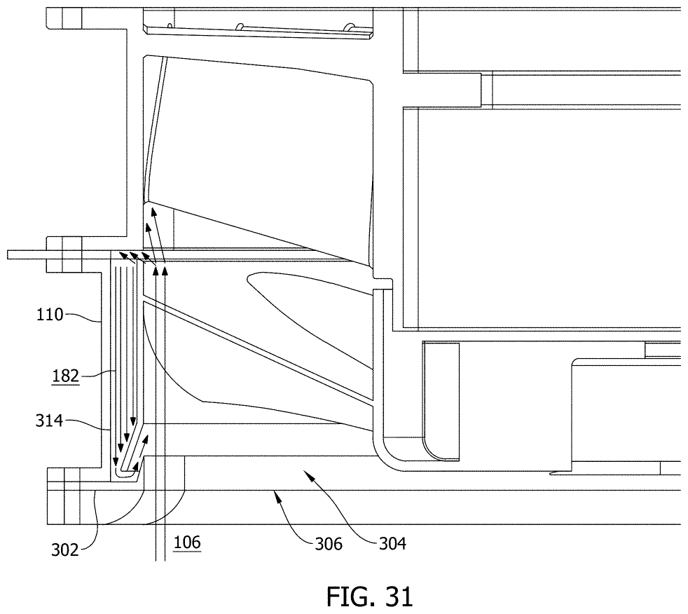

Lip section 304 and/or flared inlet section 310 can have any shape that enables recirculation inhibitor 314 to function as described herein. In one embodiment, flared inlet section 310 has a frustoconical shape such that first rim 308 has a larger diameter than main body section 312. Thus, in the cross-sectional view illustrated in FIGS. 30 and 31, flared inlet section 310 is generally planar and is oriented obliquely relative to main body section 312. Flared inlet section 310 does not have an “S, “J,” or “T” cross-sectional shape, or any partial geometry thereof. In an alternative embodiment, flared inlet section 310 has a curved cross-sectional shape that is convex relative to a centerline of vaneaxial blower system 100. In addition, lip section 304 can be oriented perpendicularly, angled, or curved concave relative to the centerline of vaneaxial blower system 100. The combination of the fan shroud geometry with the casing geometry makes it difficult for airflow 106 to recirculate. As shown in FIG. 31, the recirculated air 182 re-enters the rotor shroud 114 in the same direction as the airflow 106, and the recirculated air 182 is entrained with airflow 106.

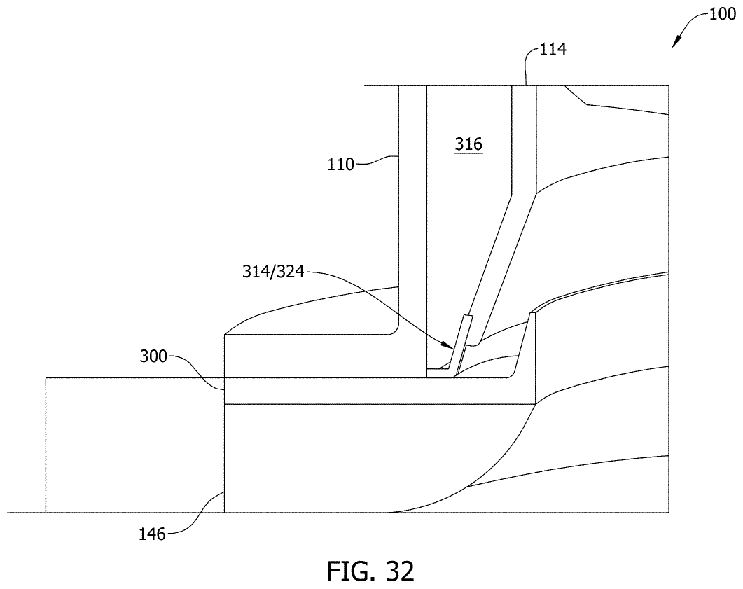

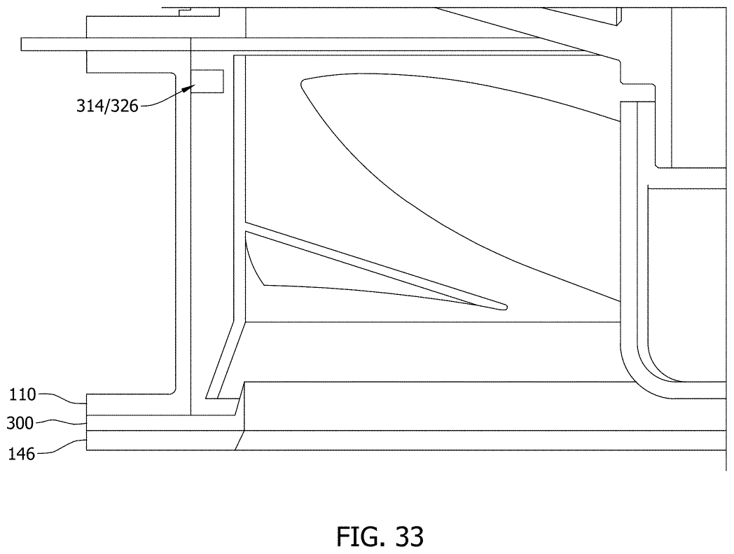

Referring to FIGS. 32 and 33, vaneaxial blower system 100 includes a recirculation inhibitor 314 coupled to rotor shroud 114, rotor housing 110, and/or inlet casing 300. For example, referring to FIG. 32, recirculation inhibitor 314 includes a restrictor flap 324 extending fully or partially between rotor shroud 114 and rotor housing 110 and/or inlet casing 300 to restrict airflow 106 through recirculation chamber 316. Flap cannot extend fully between the rotor shroud 114 and the rotor housing 110, but can only partially extend therebetween. Referring to FIG. 33, recirculation inhibitor 314 includes a sealing member 326 integral to rotor housing 110 and extending radially towards rotor shroud 114. Recirculation inhibitors 314 can be positioned at any location in which a gap is defined between rotor shroud 114 and rotor housing 110 and/or inlet casing 300. Thus, for example, sealing member 326 can be located at any longitudinal position along rotor housing 110.

Restrictor flap 324 can be fabricated from any material that enables vaneaxial blower system 100 to function as described herein. Example materials include, but are not limited to, a polymeric material or a metallic material. In addition, restrictor flap 324 can be slit at circumferential intervals, thereby creating “fingers” that are bendable when in contact with rotor housing 110 and/or inlet casing 300. Sealing member 326 can be fabricated from any material that enables vaneaxial blower system 100 to function as described herein. Example materials include, but are not limited to, a rubber material or a foam material. Sealing member 326 can also be a brush seal, coupled to one or both of rotor shroud 114 and rotor housing 110 and/or inlet casing 300.

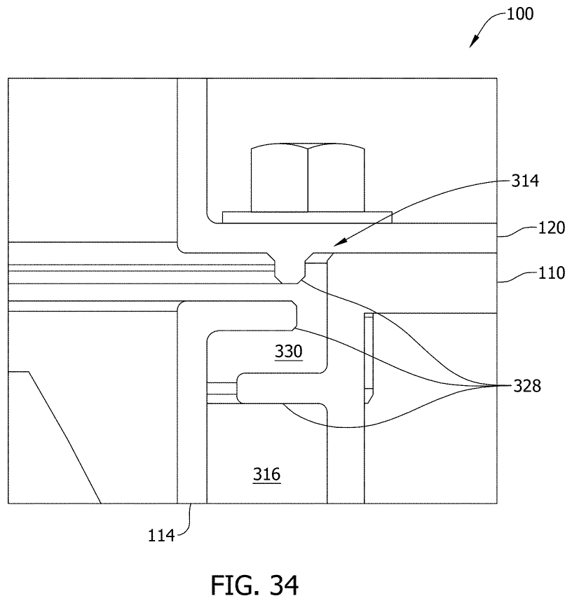

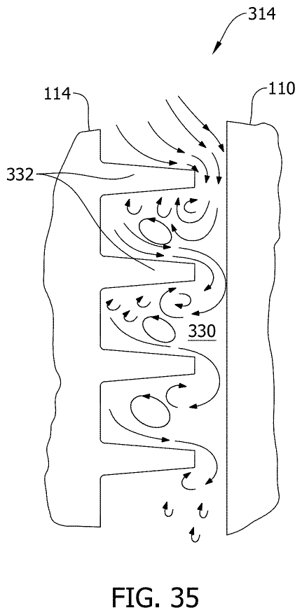

Referring to FIG. 34, recirculation inhibitor 314 is defined proximate to rotor outlet 138. For example, recirculation inhibitor 314 includes at least a portion of rotor shroud 114, rotor housing 110, and stator shroud 120, or any combination thereof. In the illustrated embodiment, each of rotor shroud 114, rotor housing 110, and stator shroud 120 includes an airflow restrictor element 328. Each airflow restrictor element 328 is oriented to extend towards one or more of the other respective components (i.e., rotor shroud 114, rotor housing 110, and stator shroud 120). Thus, airflow restrictor elements 328 define a tortuous channel 330 that restricts airflow 106 from being directed into recirculation chamber 316 between rotor shroud 114 and rotor housing 110. Referring to FIG. 35, recirculation inhibitor 314 includes a plurality of seal teeth 332, defining a labyrinth seal, coupled to rotor shroud 114. Thus, in this embodiment, seal teeth 332 define tortuous channel 330.

Airflow restrictor elements 328 or seal teeth 332 can be a separate component that is added, injection molded, or cast with its respective component. Alternatively, airflow restrictor elements 328 and sealing teeth 332 can be incorporated into vaneaxial blower system 100 in any manner that facilitates operation as described herein. In one embodiment, airflow restrictor element 328 on rotor shroud 114 can be shaped and sized to balance rotor 102. The airflow restrictor element 328 on the rotor fan 108 could be used to balance the fan such as using a balancing wheel. Additionally, the outer diameter of the rotor fan 108 can be ground in specific locations or drill holes in some sections to balance the fan.

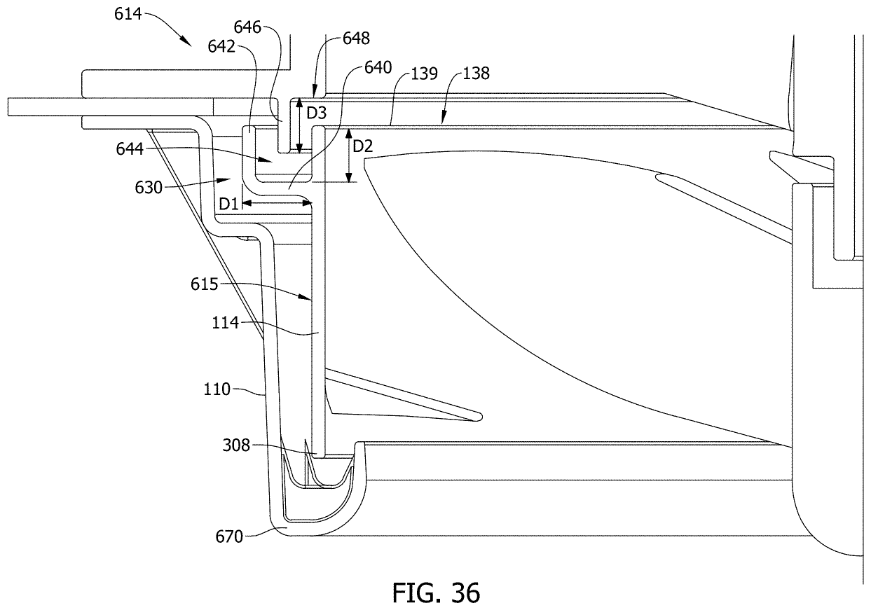

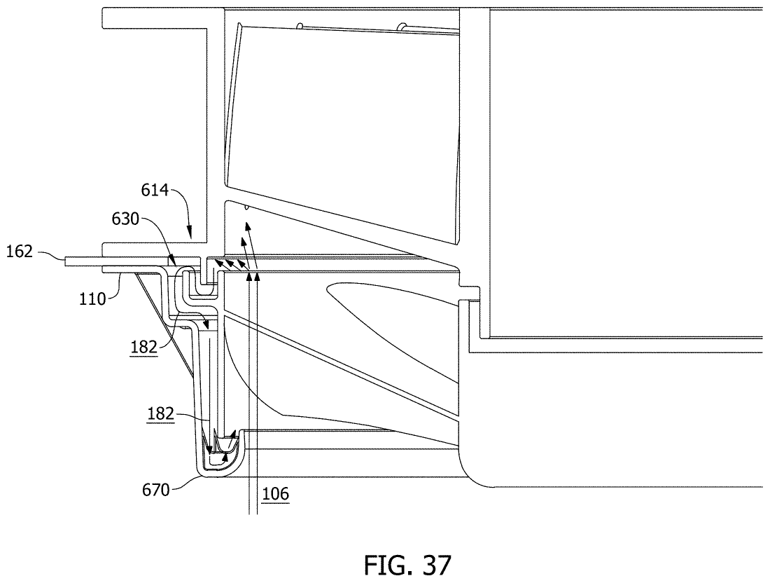

As shown in FIGS. 36 and 37, in some embodiments, a recirculation inhibitor 614 includes a tortuous channel 630 formed by a Y-shaped structure extending from an outer surface 615 of the rotor shroud 114. The tortuous channel 630 throttles airflow 106 escaping between the rotor shroud 114 and the stator shroud 120 due to a relative increase in static pressure within the tortuous channel 630. The Y-shaped structure is formed by flange 640 extending a distance Di from the outer surface 615 of the rotor shroud 114 and a rib 642 extending a distance D2 from the flange 640. The rib 642 of the rotor shroud 114 is oriented towards the outlet of the rotor shroud 114. The rib 646 of the rotor shroud 14 extends a distance D3 from an inlet surface 648 of the stator shroud 120.

When assembled, the flange 640 and rib 642 of the rotor shroud 114 define a circumferential channel 644 of the rotor shroud 114 which receives a rib 646 of the rotor shroud 114, forming an inlet of the tortuous channel 630. Stated differently, the rib 646 of the stator shroud 120 is positioned within the circumferential channel 644. In some embodiments, the rib 642 of the rotor shroud 114 does not extend beyond an edge 139 of the rotor outlet 138.

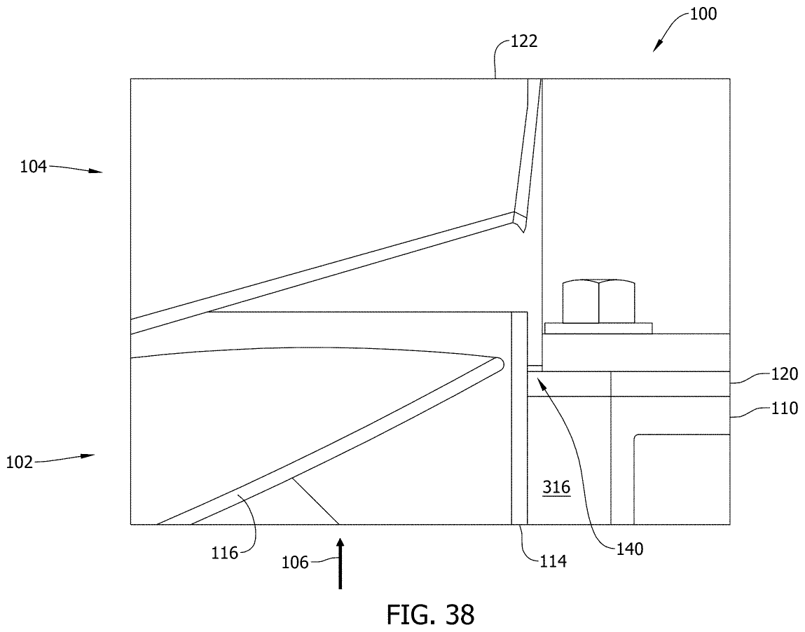

In some embodiments, the recirculated air 182 is diverted through the rotor shroud 114 by way of the lip section of 304 of the inlet casing 300 of FIG. 31. In some embodiments, the rotor housing 110 includes a lip inlet section 670. The lip inlet section 670 has a hook-shape which is oriented obliquely and/or perpendicularly relative to the rotor housing 110. In some embodiments, the lip inlet section 670 extends at least to the first rim 308 of the rotor shroud 114. In some embodiments, the lip inlet section 670 extends beyond the first rim 308 of the rotor shroud 114. The recirculated air 182 is diverted through the rotor shroud 114 by way of the lip inlet section 670 rotor housing 110 such that recirculated air 182 re-enters the rotor shroud 114 in the same direction and is entrained with the airflow 106 as shown in FIG. 37. The lip inlet section 670 of the rotor housing 110 eliminates the need of the lip section of 304 on the inlet casing 300, reducing complexity of the inlet casing 300. Referring to FIG. 38, in some embodiments, rotor shroud 114 is radially undersized relative to stator shroud 120, and extends at least partially into stator 104. Thus, airflow 106, that in other embodiments can recirculate between rotor 102 and stator 104, is directed past stator inlet 140 to bypass, and thus restrict airflow 106 from recirculating, between rotor shroud 114 and stator shroud 120.

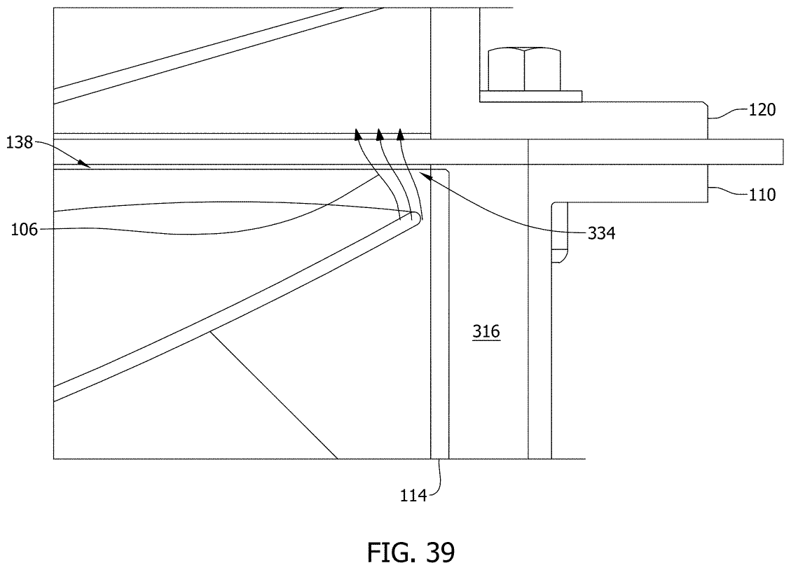

Referring to FIG. 39, in some embodiments, recirculation inhibitor 314 includes a deflector element 334 coupled to rotor shroud 114 proximate to rotor outlet 138. Deflector element 334 is oriented obliquely relative to rotor shroud 114 to facilitate directing airflow 106 radially inward and away from the interface between rotor shroud 114, rotor housing 110, and stator shroud 120. Deflector element 334 can be a separate component that is added or injection molded with rotor shroud 114.

Generally, the angles of the rotor blades 116 and the stator blades 122 are optimized for minimal flow separation along the blade span through the majority of operating conditions. Such minimal flow separation increases the efficiency and reduces the sound emission of vaneaxial blower system 100. Additionally, the number of rotor blades 116 and stator blades 122 is optimized based on at least one design criteria, such as desired airflow (CFM), static pressure, and efficiency. In the example embodiment, rotor 102 includes nine rotor blades 116 and stator 104 includes twenty-one stator blades 122. Alternatively, rotor 102 and stator 104 can include any number of blades that facilitates operation of vaneaxial blower system 100 as described herein. The cross-sections of the rotor blades 116 and the stator blades 122 are substantially constant in thickness. Alternatively, the rotor blades 116 and the stator blades 122 can define an airfoil shape having a thickness that changes between the trailing and leading edges.

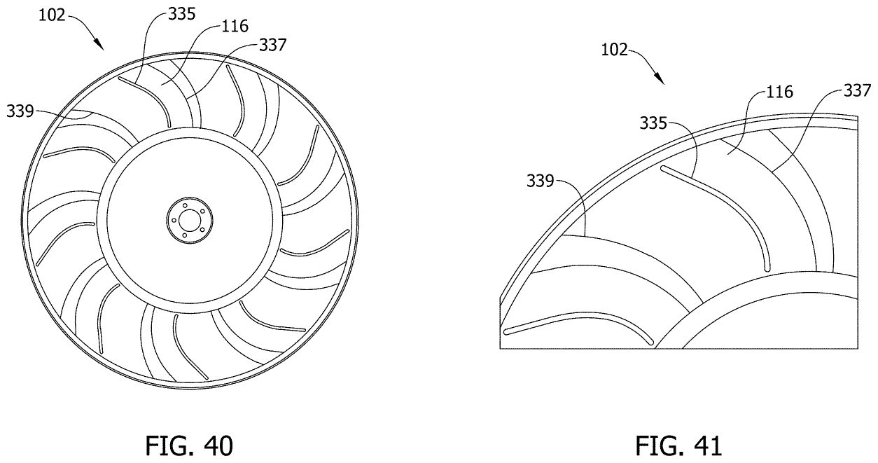

Referring to FIGS. 40 and 41, rotor blades 116 include a slot 335 defined therein. Slot 335 is defined between a leading edge 337 and a trailing edge 339 of rotor blades 116. As the system static pressure increases, the angle of attack in rotor blade 116 increases and this can result in separation of the airflow from the blade. Thus, in the illustrated embodiment, slot 335 is included in rotor blade 116 facilitate reattachment of the airflow to the surface of the blade due to negative pressure created at the slot, thereby delaying the stall (thereby mitigating stall conditions). The stall improvement can be achieved by having two separate blades in the fan rotor. For example, as the flow is separated from a first blade by increasing the static pressure of the system, the airflow will adhere to surface of the second blade due to negative pressure created at the slotted area between the two blades. In addition, adding the slot creates a negative pressure area that causes the airflow to remain attached to the blade for the entire chord length of the blade, therefore allowing the blower system 100 to run at a higher stall point.

Slot 335 can have any shape, configuration, and length that enables system 100 to function as described herein. As shown, slot 335 is contoured to correspond to the shape of at least one of leading edge 337 or trailing edge 339. Slot 335 can also be at any position between leading edge 337 or trailing edge 339 that enables system 100 to function as described herein. In one embodiment, slot 335 is added at two-thirds (⅔) of a chord length (e.g., the location where separation starts) from leading edge 337.

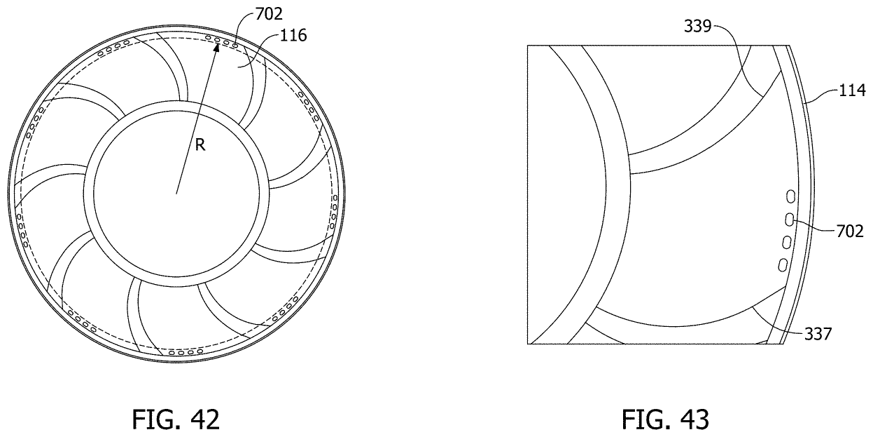

Referring to FIGS. 42 and 43, in some embodiments, a row of circumferential openings 702 extend through the blades 116. In some embodiments, the circumferential openings 702 extend from the leading edge 337 to the trailing edge 339. In some embodiments, the circumferential openings 702 extend from the leading edge 337 partially to the trailing edge 339. In some embodiments, the openings 702 extend from the leading edge 337 half-way to the trailing edge 339. In some embodiments, the circumferential openings 702 have a curved shape. In some embodiments, the circumferential openings 702 have a sinusoidal shape. In some embodiments, the circumferential openings 702 have an elongated shape. The shape of the circumferential openings is not limited to a specific geometry. In some embodiments, multiple circumferential openings 702 can be placed on a radial path.

The row of circumferential openings 702 are positioned a distance defined by a radius R as shown in FIG. 42. In some embodiments, the radius R can increase along the blade 116. In some embodiments, two rows of circumferential openings 702 are positioned a distance defined by the radius R and a radius R′ (not shown) respectively. In some embodiments, the row of circumferential openings 702 are positioned adjacent to the rotor shroud 114. In some embodiments, the circumferential openings 702 are positioned adjacent to an outer edge of the blades 116.

In some embodiments, each of the circumferential openings 702 have a diameter in the range of 0.11″ to 0.14″. The circumferential openings 702 are sized according to the amount of air volume moved through the blade 116. The circumferential openings 702 are further sized and configured to sufficiently displace enough air to increase static pressure but not so large as to waste air that could otherwise contribute to increased performance.

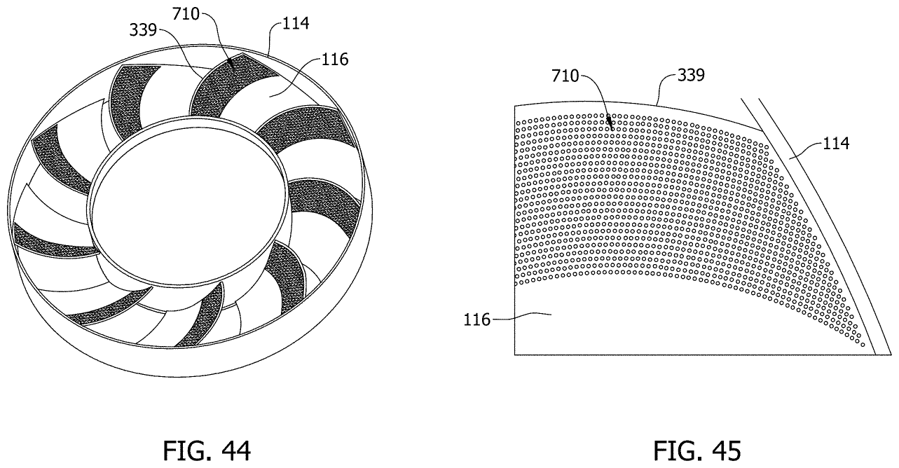

Referring to FIGS. 44 and 45, in some embodiments, an array of perforations 710 extend through the blades 116. In some embodiments, the perforations 710 extend between the rotor hub 112 and the rotor shroud 114. In some embodiments, the perforations 710 extend between the rotor hub 112 and an outer edge of the blade 116. The array of perforations 710 are sized and configured to reduce drag and reduces noise of the blades 116, which allow for more aggressive expansion angles with less turbulence.

In some embodiments, the perforations 710 partially extend from the rotor shroud 114 to the rotor hub 112. The perforations 710 are positioned along the trailing edge 339 and extend approximately one-third (⅓) towards the leading edge 337. Each of the perforations 710 have a diameter in the range of 0.034″ to 0.064″. The perforations 710 are sized according to the amount of air volume moved through the blade 116. The perforations 710 are further sized and configured to sufficiently displace enough air to increase static pressure but not so large as to waste air that could otherwise contribute to increased performance. In some embodiments, the perforations 710 have a shape selected from a circular shape, an oval shape, a triangular shape, a star-shape, a square or rectangular shape. In some embodiments, the perforations 710 fully cover each blade 116. In some embodiments, the perforations 710 partially cover each blade 116. In some embodiments, the perforations 710 partially or fully cover all blades 116. In some embodiments, the perforations 710 partially or cover less than all blades 116. In some embodiments, the perforations 710 partially or cover every other blade 116.

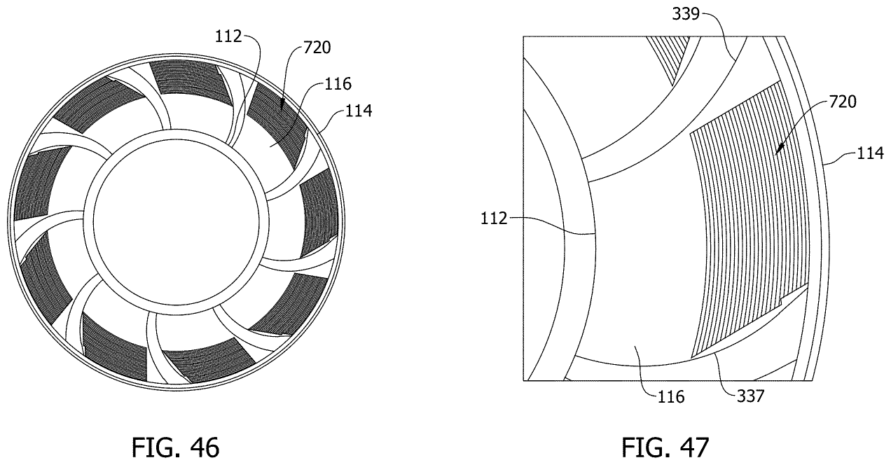

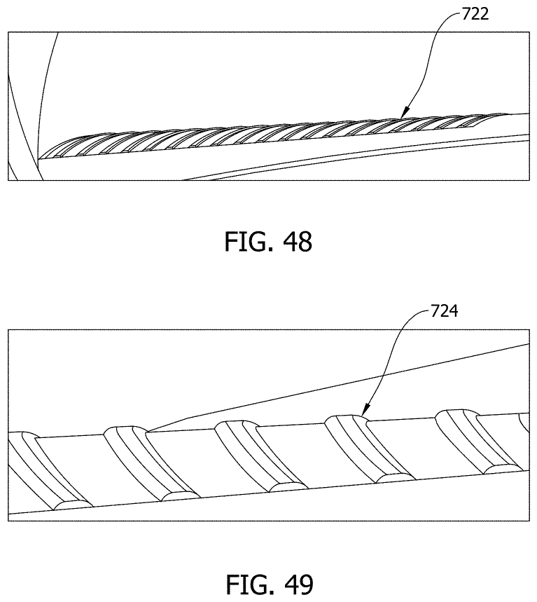

Referring to FIGS. 46 through 49, in some embodiments, a plurality of generally circumferential riblets (720, 722, 724) extend across the blade 116 from the leading edge 337 to the trailing edge 339 or a portion of the blade 116 thereof. In some embodiments, the plurality of circumferential riblets (720, 722, 724) are adjacent to the rotor shroud 114 and extend a distance to the rotor hub 112. In some embodiments, the plurality of circumferential riblets (720, 722, 724) are adjacent to the rotor shroud 114 or extend a distance to an outer edge of the blades 116. In some embodiments, the plurality of circumferential riblets (720, 722, 724) are adjacent to the rotor shroud 114 and extend to the rotor hub 112. As shown in FIG. 48, in some embodiments, the plurality of circumferential riblets 722 are configured as channels within the surface of the blade 116.

As shown in FIG. 49, the plurality of circumferential riblets 724 protrude and/or inscribe from the surface of the blade 116. In some embodiments, the plurality of circumferential riblets 724 include openings within the plurality of circumferential riblets 724. In some embodiments, the plurality of circumferential riblets 724 are a series of riblets with flat surfaces in-between. In some embodiments, the plurality of circumferential riblets 724 have a sinusoidal shape. In some embodiments, the plurality of circumferential riblets 724 are positioned on each of the blades 116. In some embodiments, the plurality of circumferential riblets 724 are positioned on less than all blades 116. In some embodiments, plurality of circumferential riblets 724 are positioned on every other blade 116. In some embodiments, the riblets 724 do not have to have a uniform geometry. In some embodiments, the thickness and spacing of the riblets 724 can vary from riblet to riblet on a blade. Additionally, in some embodiments, the riblet 724 can vary in thickness along the circumferential path.

As air passes through the plurality of circumferential riblets (720, 722, 724), the air can travel at a higher relative velocity and still be attached to the blade. The plurality of circumferential riblets (720, 722, 724) are further configured to confine the airflow 106 to a channel defined by the space between circumferential riblets (720, 722, 724) which decreases the velocity in two directions and increases the velocity in the desired direction, thereby increasing the overall performance. Less turbulence results in better overall performance and a reduction in noise.

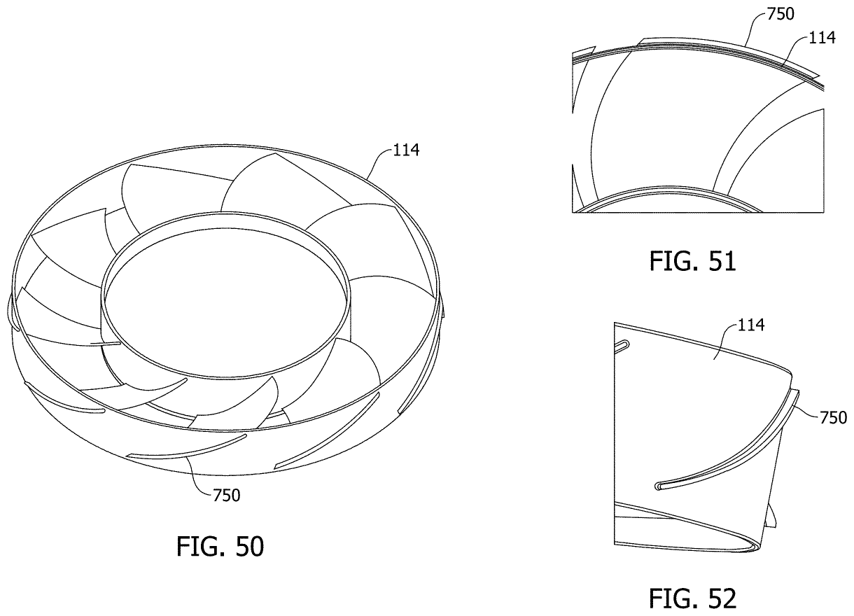

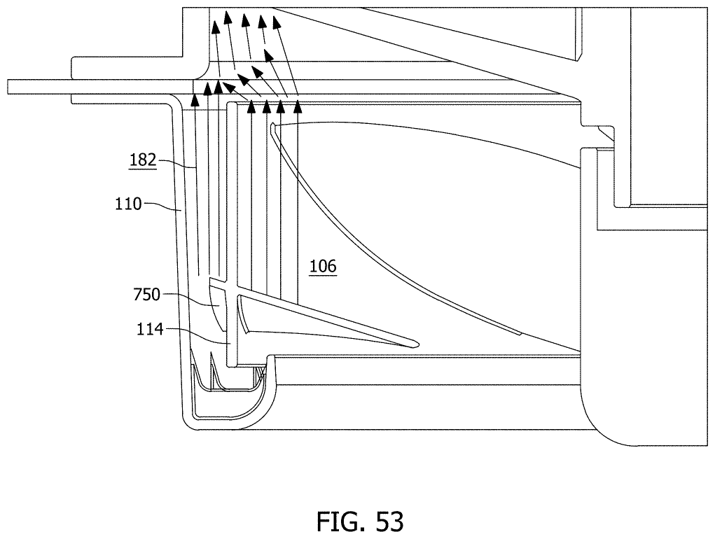

As shown in FIGS. 50 through 53, in some embodiments, external fan blades 750 extend from the rotor shroud 114 such that the external fan blades 750 create a flow of air in the same direction as the fan blades 116 on the inside of the rotor fan shroud 114. The number of external fan blades 750 are not limited to the number of fan blades 116 on the inside of the rotor shroud 114, but can be any number of external fan blades 750. In some embodiments, the geometry, relative placement, and location of the external fan blades 750 are not limited to the geometry of the fan blades 116 on the inside of the rotor shroud 114, but can take any geometry.

The external fan blades 750 have a geometry configured to generate air flow in the same direction as the air flow generated by the fan blades 116. As best shown in FIG. 52, by generating an air flow on the outside of the rotor shroud 114, static pressure between the rotor housing 110 and the rotor shroud 114 increases such that recirculated air 182 which would otherwise escape is pushed back into the system, thus increasing the static pressure stall point of the blower system.

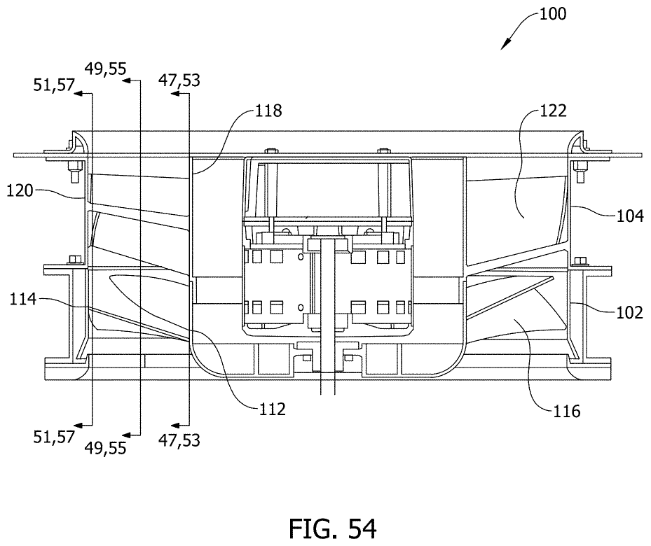

FIGS. 54-69 illustrate the geometry of the rotor blades 116 and the stator blades 122 of the vaneaxial blower system 100. Generally, the angles of the rotor blades 116 and the stator blades 122 are optimized for minimal flow separation along the blade span through the majority of operating conditions. Such minimal flow separation increases the efficiency and reduces the sound emission of vaneaxial blower system 100. Additionally, the number of rotor blades 116 and stator blades 122 is optimized based on at least one design criteria, such as desired airflow (CFM), static pressure, and wattage. In the example embodiment, rotor 102 includes 9 rotor blades 116 and stator 104 includes 21 stator blades 122. Alternatively, rotor 102 and stator 104 may include any number of blades that facilitates operation of vaneaxial blower system 100 as described herein.

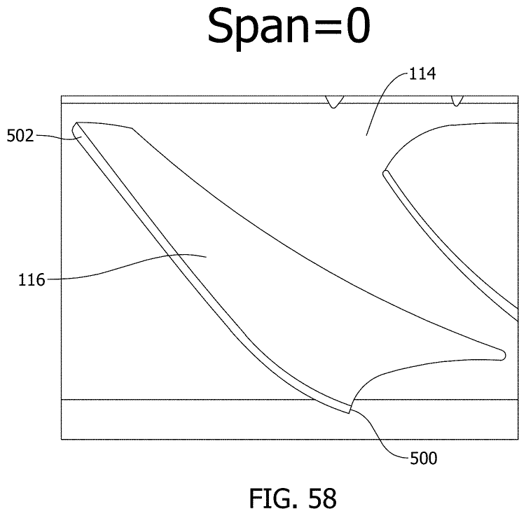

FIG. 54 illustrates a cross-sectional view of vaneaxial blower system 100 illustrating the locations of cross-sectional views shown in FIGS. 58, 60, 62, 64, 66, and 68 as a function of the span length of the rotor blades 116 and the stator blades 122. Specifically, Line 47,53 illustrates the location of a cross-section taken at span 0 in close radial proximity to the rotor hub 112 and the stator hub 118. Similarly, Line 49,55 illustrates the location of a cross-section taken at span 0.5 at a midpoint of the span lengths of the rotor blades 116 and the stator blades 122 between the hubs 112 and 118 and the shrouds 114 and 120 Also, Line 51,57 illustrates the location of a cross-section taken at span 1 in close radial proximity to the rotor shroud 114 and the stator shroud 120.

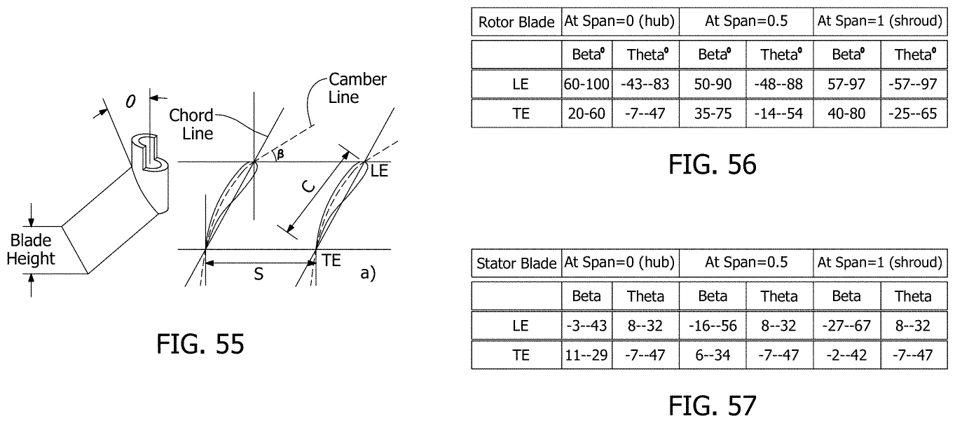

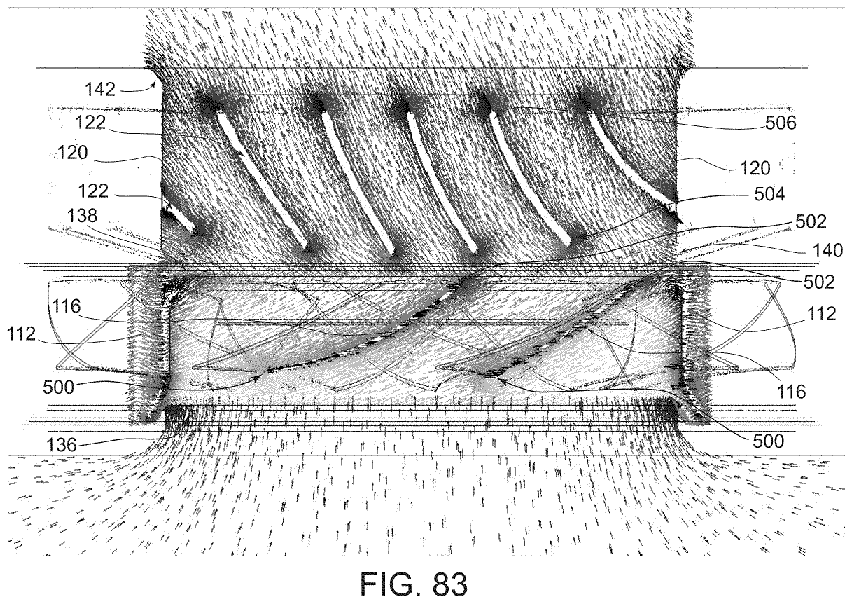

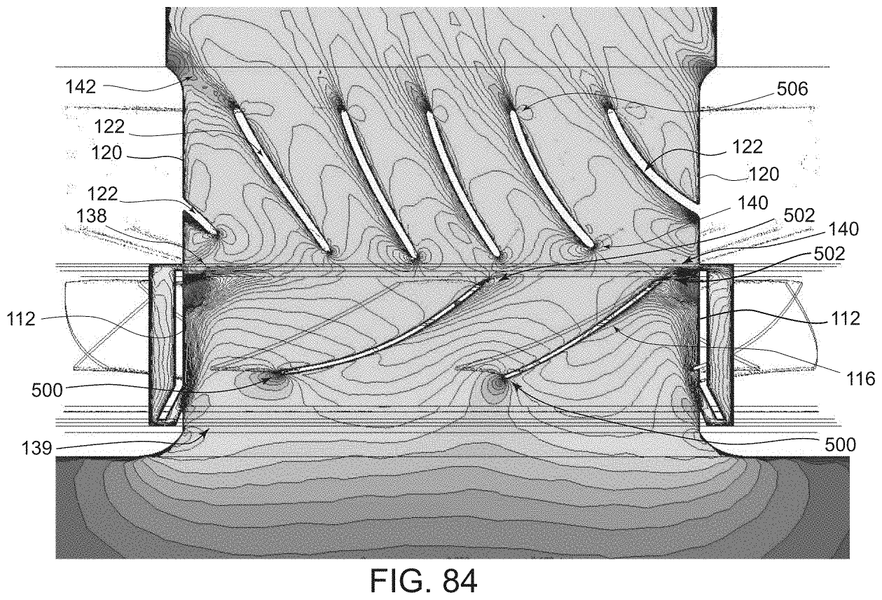

FIG. 55 is a schematic diagram of rotor blade 116 and stator blade 122 angles of the vaneaxial blower system 100. FIG. 83 illustrates a vector plot and flow simulation of airflow through the rotor blade 116 and stator blade 122. FIG. 84 illustrates a contour plot and flow simulation of airflow through the rotor blade 116 and stator blade 122. The plots of FIGS. 83 and 84 are taken at the rotor hub 112 and stator hub 122 respectively (also reffered to as “span 0” as explained in further detail below). As shown in FIGS. 55, 83 and 84, in the example embodiment, each rotor blade 116 includes a leading edge 500 positioned on the rotor inlet 136 side of the rotor blade 116, and a trailing edge 502 positioned on the rotor outlet 138 side of the rotor blade 116. Similarly, each stator blade 122 includes a leading edge 504 positioned on the stator inlet 140 side of the stator blade 122, and a trailing edge 506 positioned on the stator outlet 142 side of the stator blade 122. As shown in FIG. 55, the beta (β) angle is defined as the angle measured between the camber line of the blades 116 and 122 and a horizontal tangential line that extends through the respective leading edge 500 or 504 or trailing edge 502 or 506. Still referring to FIG. 55, the blade is positioned in the xy plane with the z direction being the axis of rotation. Leading edges 500 and 504 and trailing edges 502 and 506 are defined by the line in the zx plane and by the theta (θ) angle. Theta determines a line from the positive x axis. Theta is the angle between a line and x+axis.

These beta and theta angles are optimized at various spans across the blade such as Span 0 (hub), Span 0.5 (half the width of the blade), and Span 1 (shroud or tip of blade). The blade is then swept to intersect these geometries at the various spans which defines the geometry of the blade. Since the geometries at the various spans form the overall geometry of the blade, any changes to the beta and/or theta angle at any span length will impact the output conditions of the blade.

FIG. 56 is a table of example rotor blade 116 angles at various points along the rotor blade 116 span. Specifically, FIG. 56 illustrates a range of beta angles and theta angles for the leading edge 500 and trailing edge 502 of rotor blades 116 at each of span 0, span 0.5, and span 1.

FIG. 57 is a table of example stator blade 122 angles at various points along the stator blade 122 span. Specifically, FIG. 57 illustrates a range of beta angles and theta angles for the leading edge 504 and trailing edge 506 of stator blades 122 at each of span 0, span 0.5, and span 1.

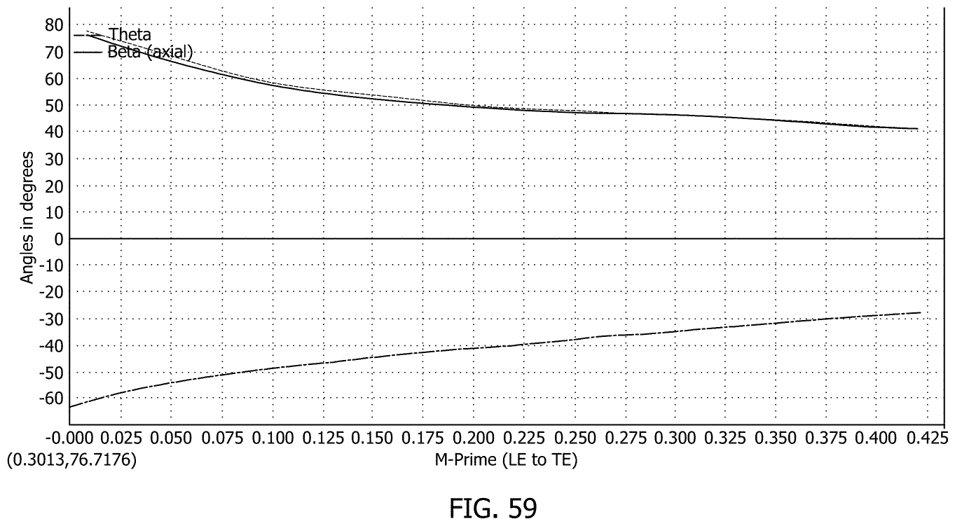

FIG. 58 is a cross-sectional view of a rotor blade 116 at span 0 proximate the rotor hub 112, and FIG. 59 is a graph of the theta angle and the beta angle from the leading edge 500 to the trailing edge 502 of rotor blade 116 at span 0. FIG. 59 illustrates that, at span 0, the beta angle decreases toward 0.0, non-linearly, in degree from the leading edge 500 to the trailing edge 502. Alternatively, at span 0, the theta angle increases toward 0.0, non-linearly, in degree from the leading edge 500 to the trailing edge 502.

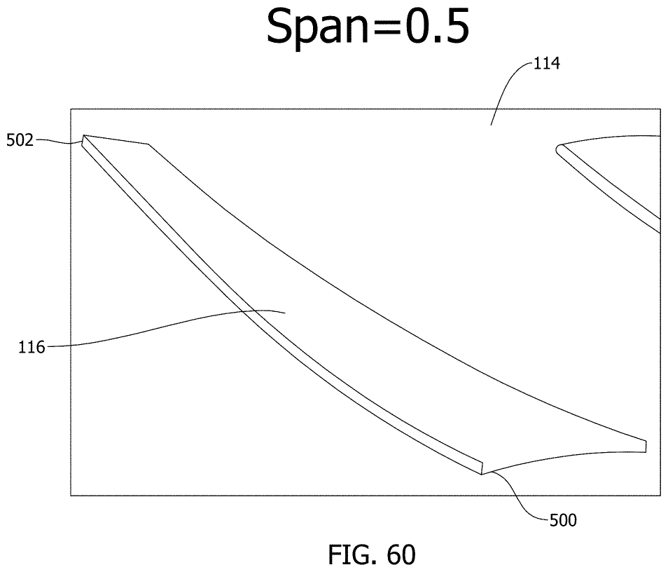

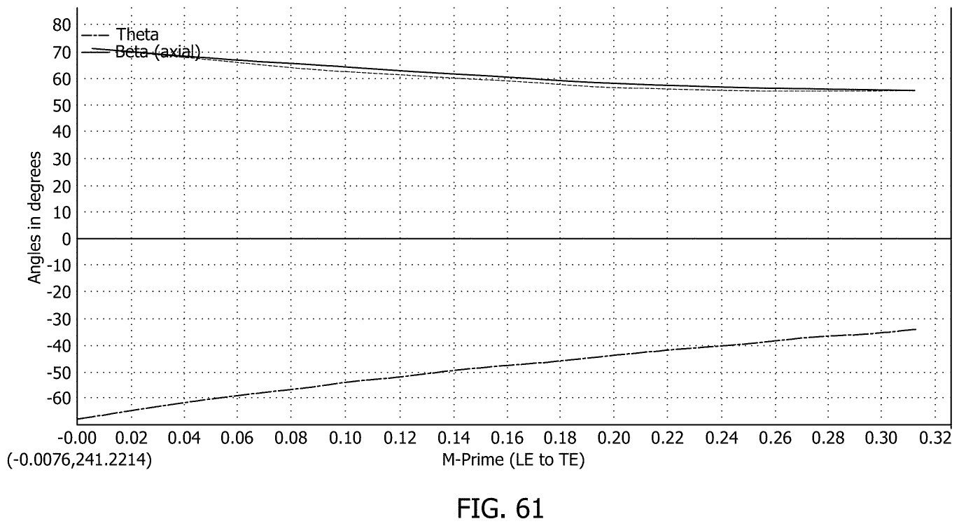

FIG. 60 is a cross-sectional view of a rotor blade 116 at span 0.5 between the rotor hub 112 and the rotor shroud 114, and FIG. 61 is a graph of the theta angle and the beta angle from the leading edge 500 to the trailing edge 502 of the rotor blade 116 at span 0.5. FIG. 61 illustrates that, at span 0.5, the beta angle decreases toward 0.0, non-linearly, in degree from the leading edge 500 to the trailing edge 502. Alternatively, at span 0.5, the theta angle increases toward 0.0, non-linearly, in degree from the leading edge 500 to the trailing edge 502.

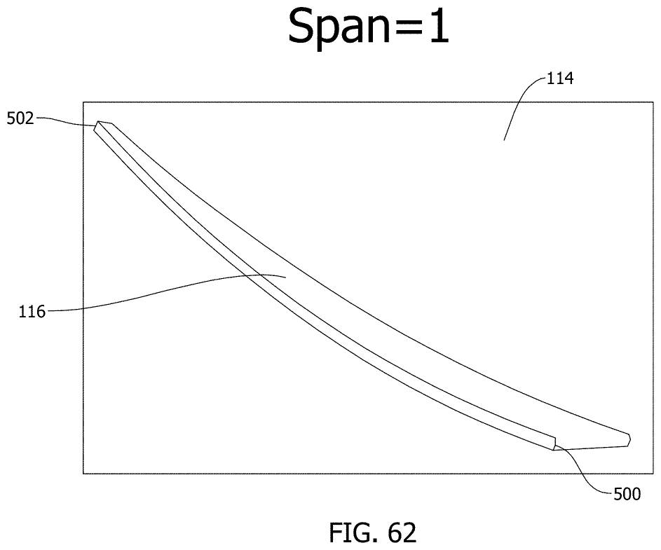

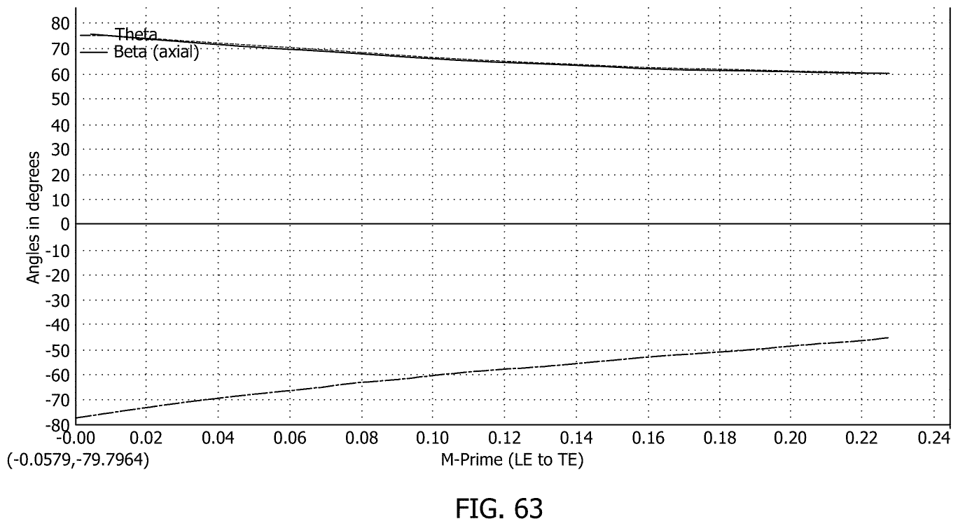

FIG. 62 is a cross-sectional view of a rotor blade 116 at span 1 proximate the rotor shroud 114, and FIG. 63 is a graph of the theta angle and the beta angle from the leading edge 500 to the trailing edge 502 of rotor blade 116 at span 1. FIG. 63 illustrates that, at span 1, the beta angle decreases toward 0.0, non-linearly, in degree from the leading edge 500 to the trailing edge 502. Alternatively, at span 1, the theta angle increases toward 0.0, non-linearly, in degree from the leading edge 500 to the trailing edge 502. The graphs of FIGS. 59, 61, and 63 show that as the span of rotor blade 116 increases, the rate of change of both the theta angle and the beta is decreasing between the leading edge 500 and the trailing edge 502.

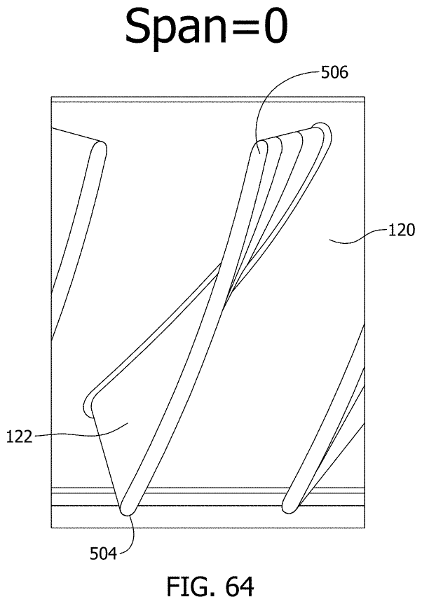

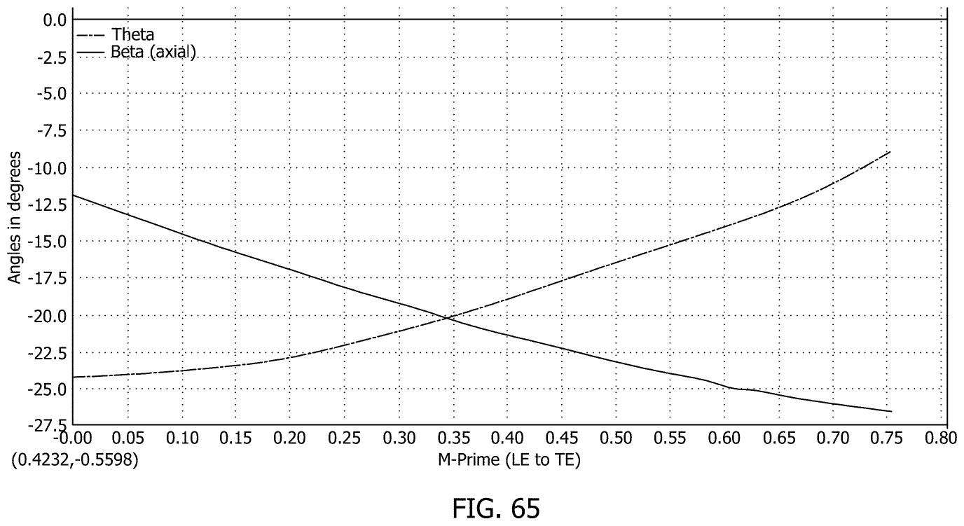

FIG. 64 is a cross-sectional view of stator blade 122 at span 0 proximate the stator hub 118, and FIG. 65 is a graph of the theta angle and the beta angle from the leading edge 504 to the trailing edge 506 of stator blade 122 at span 0. FIG. 65 illustrates that, at span 0, the beta angle increases toward 0.0, non-linearly, in degree from the leading edge 504 to the trailing edge 506. Alternatively, at span 0, the theta angle decreases away from 0.0, non-linearly, in degree from the leading edge 504 to the trailing edge 506. The beta angle and the theta angle are substantially similar at a point toward the leading edge 504 side of the midpoint between the leading edge 504 to the trailing edge 506.

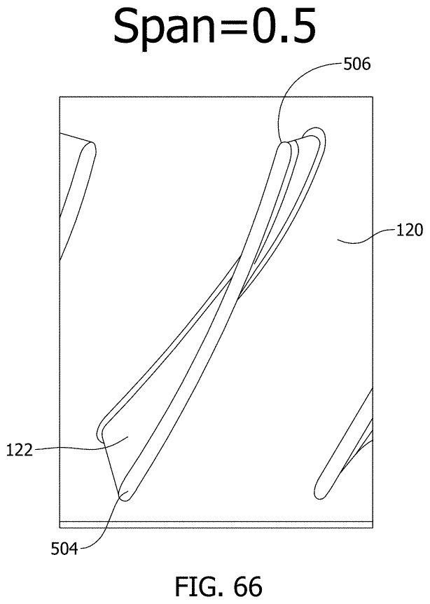

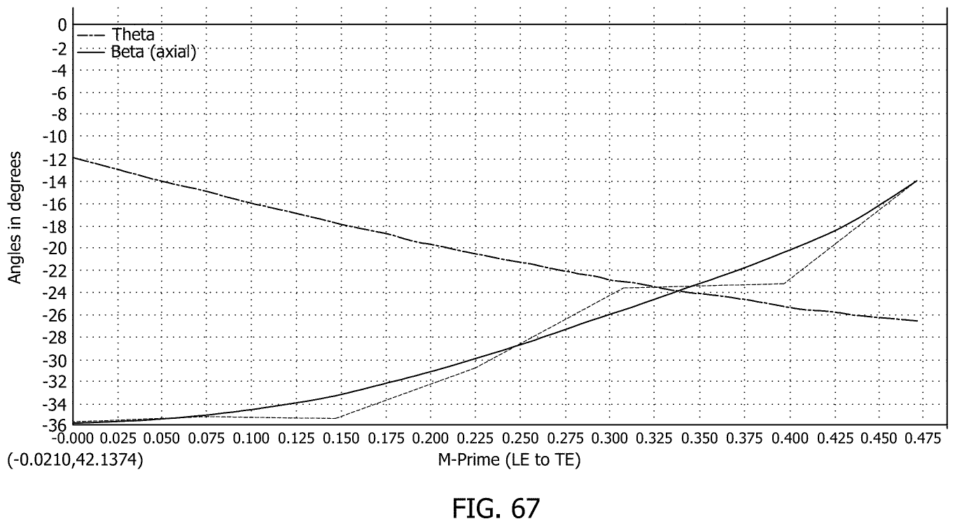

FIG. 66 is a cross-sectional view of stator blade 122 at span 0.5 between the stator hub 118 and the stator shroud 120, and FIG. 67 is a graph of the theta angle and the beta angle from the leading edge 504 to the trailing edge 506 of stator blade 122 at span 0.5. FIG. 67 illustrates that, at span 0.5, the beta angle increases toward 0.0, non-linearly, in degree from the leading edge 504 to the trailing edge 506. Alternatively, at span 0.5, the theta angle decreases away from 0.0, non-linearly, in degree from the leading edge 504 to the trailing edge 506. The beta angle and the theta angle are substantially similar at a point toward the trailing edge 506 side of the midpoint between the leading edge 504 to the trailing edge 506.

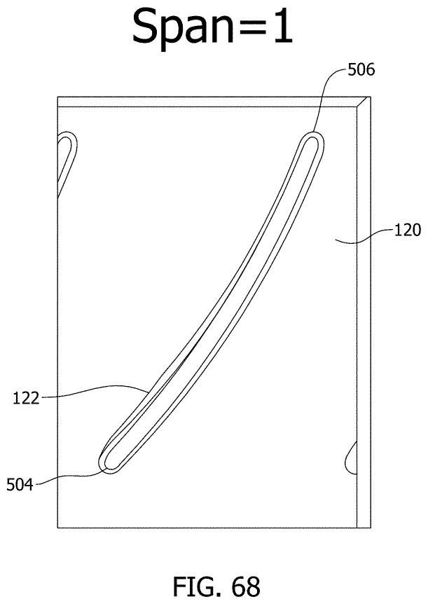

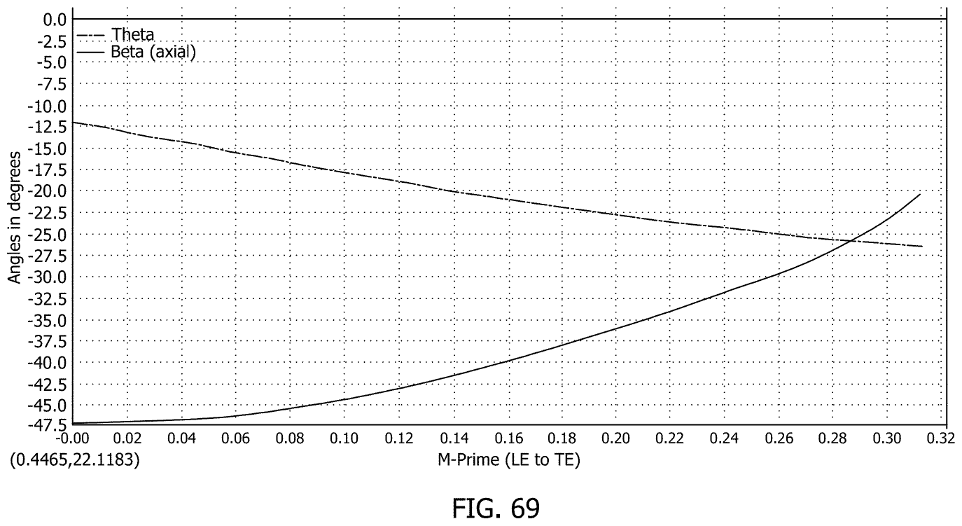

FIG. 68 is a cross-sectional view of stator blade 122 at span 1 proximate the stator shroud 120, and FIG. 69 is a graph of the theta angle and the beta angle from the leading edge 504 to the trailing edge 506 of stator blade 122 at span 1. FIG. 69 illustrates that, at span 1, the beta angle increases toward 0.0, non-linearly, in degree from the leading edge 504 to the trailing edge 506. Alternatively, at span 1, the theta angle decreases away from 0.0, non-linearly, in degree from the leading edge 504 to the trailing edge 506. The beta angle and the theta angle are substantially similar at a point proximate the trailing edge 506.

Referring to FIGS. 83 and 84, the configurations of beta and theta angles of the blades are optimized to provide specific flow rate at a specific pressure. Generally, in optimizing for flow rate and pressure, the parameters considered are flow rate, static pressure, noise, and power consumption. The requirement for noise level is to not exceed noise level requirements of centrifugal fans used in the art for the particular application (such as residential or commercial settings which require low noise levels). The power efficiency is at a maximum for the parameters considered. The blade geometry and angles are selected to achieve the optimum combination of these requirements. An iterative process was employed to vary these angles and arrive at the optimum combination.

The rotor 102 rotates under the power of a motor 126 of FIG. 1 while the stator 104 remains stationary. The rotor blades 116 split the airflow into two streams (suction and pressure) as the rotor 102 accelerates to a required velocity and smoothly reunite the streams at the trailing edge 502 of the rotor blades 116. Air enters the rotor 102 from a hemispherical area in front of the entry lip section 304 (of FIGS. 29 and 31). The rotor blades 116 have an angle-of-attack such that they will produce air movement (airflow) through the rotor 102. The airflow accelerates to a desired velocity as it follows across the rotor blade 116 surface.

A boundary layer develops across the leading edge 500 of the rotor blade 116, radially outward from the rotor hub 112 and from the leading edge 500 to the trailing edge 502. The air remains attached to the rotor blade 116 as long as the velocity, viscosity, and friction parameters remain balanced. If the velocity is too high, the boundary layer will separate from the surface and begin to tumble, which indicates the onset of a stall condition and is detrimental to the overall performance. The provided geometries (angles and measurements) along the rotor blades 116 contribute to the smooth flow of air along the rotor blades 116 from leading edge 500 to trailing edge 502 and from the rotor hub 112 to the blade tip. These geometry can be selected such that the pressure, flow, sound, and power consumption are optimized.

The stator blades 122 are configured with a geometry such that, as the air leaves the trailing edge 205 of the rotor blades 116, the air attaches to the stator blades 122 with as little turbulence as possible. The stator blades 122 are configured to straighten any swirling airflow from the rotor 102 and to convert the velocity of the air to pressure by reducing the velocity. The geometry is therefore selected to reduce the occurrences of air separation and minimize noise created from the conversion of air velocity to pressure.

The geometry (angle and contour) of the blades 116, 122 at the respective hubs 112, 118 contribute not only to the mechanical strength of the blades 116, 122 but to the angle-of-attack. The selection of the geometry can limit the amount of change to the contour of the blades 116, 122. As the chords of the blades 116, 122 move away from the respective hubs 112, 118, the blades 116, 122 are contoured to provide the optimal performance within the limits of the above requirements insomuch as the boundary layer does not separate and the blades 116, 122 is manufacturable based on the selected method of manufacture; molded, machined, and the like.

At the tip of the rotor blade 116, the geometry selected is optimized to the same requirements with the added consideration of the air flowing radially off the tip of the rotor blade 116. Techniques can be used, by varying the design angles and contours of the tip, to minimize these tip effects. Noise can be a major consideration when selecting these parameters. The stator 104 has the same requirements as the rotor 102 with the exception that the tips of the stator blades 122 are typically attached to the stator shroud 120, which provides structural support to the stator blades 122. The contour along the chord and span of the blades 116, 122 between the respective hubs 112, 118 and tips can be selected within the limits of manufacturability to optimize the attached flow along the blades 116, 122. Additionally, the trailing edge 502 of the rotor blades 116 are axially spaced from the leading edge 504 of the stator blades 122 by an optimized distance based on the radial distance from the rotation axis. Specifically, at a radial location corresponding to the stator hub 118 and rotor hub 112, the trailing edge 502 of the rotor blades 116 are spaced from the leading edges 504 of the stator blades 122 by a distance of approximately between 0.1 inches to 1.1 inches. Similarly, at a radial location corresponding to the stator shroud 120 and rotor shroud 114, the trailing edge 502 of the rotor blades 116 are spaced from the leading edges 504 of the stator blades 122 by a distance of approximately between 0.8 inches to 1.8 inches.

Rotor shroud 114 further improves efficiency and noise attenuation of vaneaxial blower system 100 due to the lack of any gap between the rotor blades 116 and the rotor shroud 114. Since the tip clearance is essentially zero, any flow disturbances caused by the tip are prevented or significantly reduced. Such tip disturbances cause inefficiencies and noise, so reducing tip disturbances also reduces noise and improves efficiency.

Furthermore, in one embodiment, either or both the trailing edge 502 of the rotor blades 116 and the leading edge 504 of the stator blades 122 are serrated to reduce blade pass noise. During operation, the airflow follows the surface of blades 116 and 122 in a direction perpendicular to the blade axis. Near the trailing edges 502 and 506, the boundary layer breaks away from the blades 116 and 122 and the airflow flow becomes turbulent. Vortices then appear and create noise. The serrations cause the transition from the blades 116 and 122 to the free airflow to be softened, leading to less vortices and lower noise.

In the example embodiment, the cross-sections of the rotor blades 116 and the stator blades 122 are substantially constant in thickness. Alternatively, the rotor blades 116 and the stator blades 122 may define an airfoil shape having a thickness that changes between the trailing and leading edges.

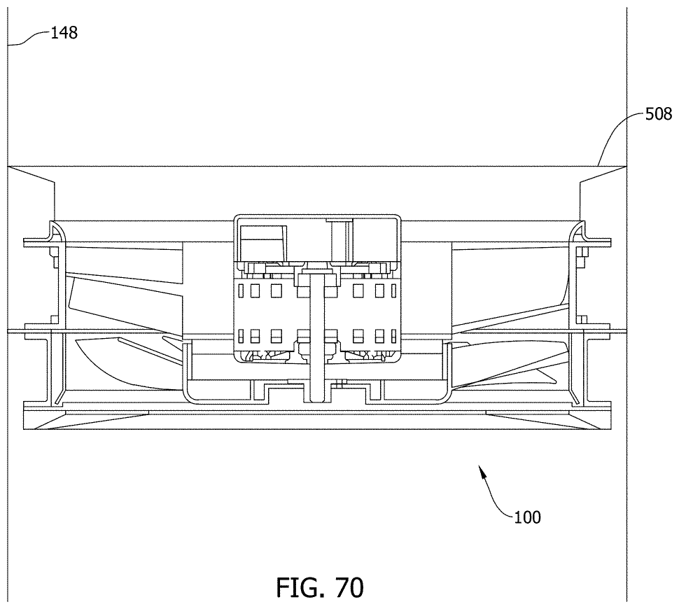

In an additional embodiment, the vaneaxial blower system 100 may include various features that result in a reduced sound output. In one embodiment, shown in FIG. 70 the vaneaxial blower system 100 is positioned within the air moving system 148 and includes an air flow diffuser 508 positioned at the blower system outlet 144 of the vaneaxial blower system 100. Specifically, the diffuser 508 is coupled to at least one of the stator shroud 120 or the surrounding air moving system 148. In operation, diffuser 508 channels the air exiting the vaneaxial blower system 100 to minimize the turbulence within the air moving system 148, which reduces sound within the air moving system 148.

In one embodiment, in a configuration opposite that of the inlet air flow director 146 the diffuser 508 has an inlet 510 with a circular shape and an outlet 512 with a rectangular shape. The circular inlet 510 captures substantially all of the air exiting the vaneaxial blower system 100 and transitions the shape of the flow toward the rectangular outlet 512 to match the shape of a downstream duct of air moving system 148. As such, the air exiting the diffuser 508 is aligned with the air moving system 148, and vibrations caused by the airflow impinging upon the air moving system 148 are attenuated.

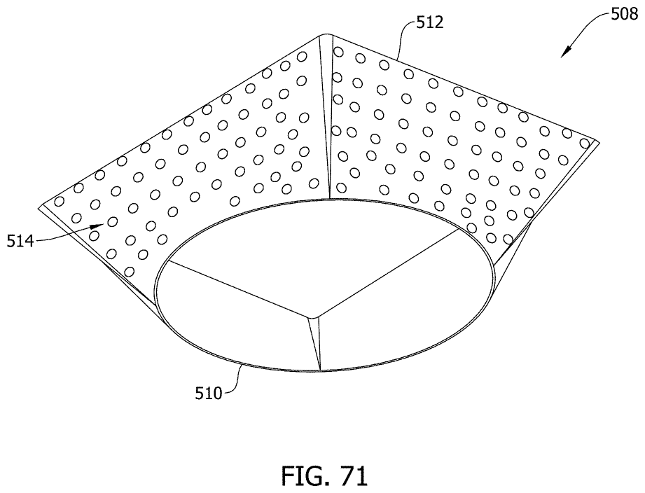

Furthermore, as shown in FIG. 71 the diffuser 508 may include a plurality of perforations 514 to further attenuate noise levels. In one implementation, the entirety of the diffuser 508 includes perforations 514 while in another embodiment, only portions of the diffuser 508 include perforations 514. In this embodiment, perforations 514 are circular. Alternatively, perforations 514 may be any other shape, for example, without limitation, ellipses or polygons, that enables diffuser 508 to function as described herein. In the example embodiment, perforations 514 may be formed such that they facilitate increasing the rigidity of diffuser 508. Perforations 514 can be applied either continuously or discontinuously along diffuser 508, and can vary in both size and shape. Thus, perforations 514 can be customized and particularly placed based on specific airflow characteristics at specific locations within diffuser 508.

Perforations 514 facilitate increasing the rigidity of diffuser 508. An increase in rigidity can facilitate decreasing the mechanical noise generated by vaneaxial blower system 100. The diffuser 508 is absorbed by structural damping due to increased rigidity. By increasing structural damping of diffuser 508, mechanical noise can be reduced.

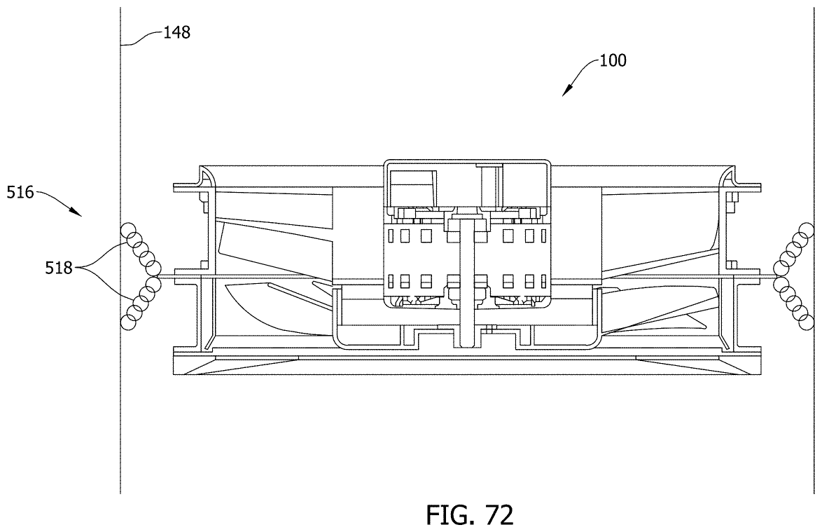

FIG. 72 illustrates another embodiment of vaneaxial blower system 100 that reduces the noise level during operation. In this embodiment, vaneaxial blower system 100 is coupled to the surrounding air moving system 148 via a suspension system 516. In the illustrated embodiment, the suspension system 516 isolates the vaneaxial blower system 100 from the air moving system 148 such that vibrations of the vaneaxial blower system 100 are not transmitted to the air moving system 148. Specifically, the suspension system 516 includes a plurality of flexible biasing devices 518 such as but not limited to springs, that are coupled to both the vaneaxial blower system 100 and to the air moving system 148. These biasing devices 518 absorb much of the vibrations from vaneaxial blower system 100 during operation and reduce the transmissions of such vibrations to the air moving system 148. While the suspension system 516 described herein includes biasing devices 518, the suspension system 516 may include any type of device that absorbs vibrations and isolates the vaneaxial blower system 100 from the air moving system 148.

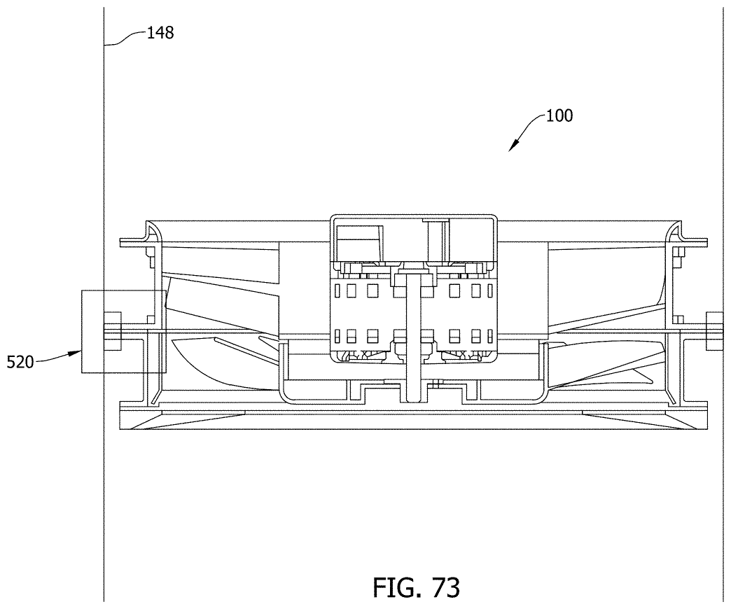

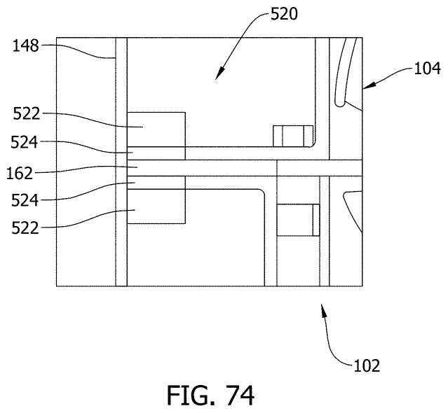

FIGS. 73 and 74 illustrate another embodiment of vaneaxial blower system 100 that reduces the noise level during operation. In this embodiment, vaneaxial blower system 100 is coupled to the surrounding air moving system 148 via a dampening system 520. Similar to the suspension system 516 the dampening system 520 isolates the vaneaxial blower system 100 from the air moving system 148 such that vibrations of the vaneaxial blower system 100 are not transmitted to the air moving system 148. Specifically, the dampening system 520 includes mounting rails 522 mounted to the air moving system 148 and configured to receive the mounting plate 162 of the vaneaxial blower system 100. A pair of dampeners 524 are positioned between the mounting plate 162 and the rails to insulate the air moving system 148 from the vibrations of the vaneaxial blower system 100. The dampeners 524 are formed from a material, such as but not limited to, rubber, that will absorb vibrations from the vaneaxial blower system 100 and reduce transmission of those vibrations to the mounting rails 522 and surrounding air moving system 148.

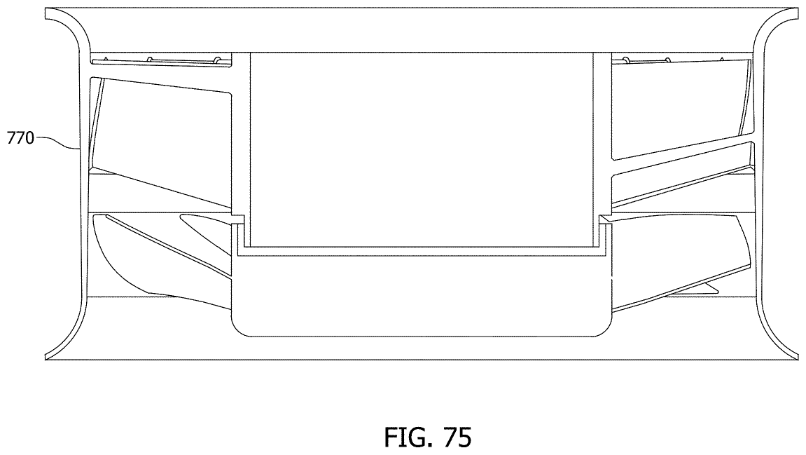

As shown in FIG. 75, in some embodiments, the stator shroud 120 and rotor housing 110 of FIG. 1 are a unitary body 770, eliminating escaping air and reducing air recirculation. The unitary body 770 has the same features as the vaneaxial blower system 100 as described in FIGS. 1 and 26. Utilizing a unitary body for the stator shroud and rotor housing reduces assembly and system complexity. In some embodiments, the unitary body 770 is made from a casting and machining operation. Adding a machining operation provides tighter tolerances resulting in improved blade tip clearance between the blade tip and the inner wall of the unitary body 770. Furthermore, utilizing a unitary body reduces noise and increases overall performance of the system. The unitary body allows for more uniformity and reduction of connecting sections which decreases the areas of air leakage in the system. The reduction in air leakage in the system reduces noise and increases overall performance.

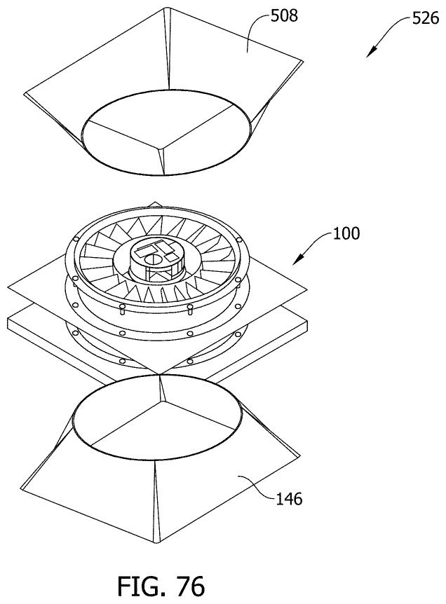

In an additional embodiment, as illustrated in FIG. 76, the vaneaxial blower system 100 can be retroactively installed in an existing air moving system 148 of an indoor air moving system and still maintain the efficiency benefits of the vaneaxial blower system 100. Specifically, a retrofit system package 526 can be installed in the air moving system 148 of an existing indoor air moving system. The retrofit system package 526 includes the vaneaxial blower system 100 and can include either or both of the inlet air flow director 146 and diffuser 508 described herein. The inlet air flow director 146 allows for vaneaxial blower system 100 to be used effectively in any indoor air moving systems regardless of the coil geometry by funneling the different air flow patterns to a center cylindrical rotor inlet 136. Similarly, the diffuser 508 allows for vaneaxial blower system 100 to effectively work in any indoor air moving system. Additionally, the inlet air flow director 146 and diffuser 508 can be any shape that facilitates operation of the vaneaxial blower system as described herein.

The retrofit system package 526 would ideally be sized to fit into the same or less space utilized by original air moving system blower. Inlet and outlet of the total retrofit system package 526 can be adjustable to fit/latch up to different duct sizes. The retrofit system package 526 would minimalize parts and assembly needed by the installer. The increased efficiency of the retrofit system package 526 would allow for old systems to be upgraded to current DOE and industry efficiency standards without needing to buy a completely new air moving system. The total retrofit enclosure can be rectangular, cylindrical, or a combination thereof. The retrofit system package 526 can also be expanded to further include a square shaped, A shaped, V shaped or circular evaporator coil and/or heating elements.

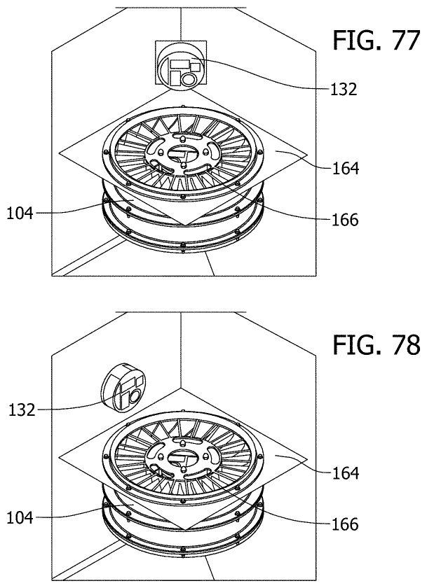

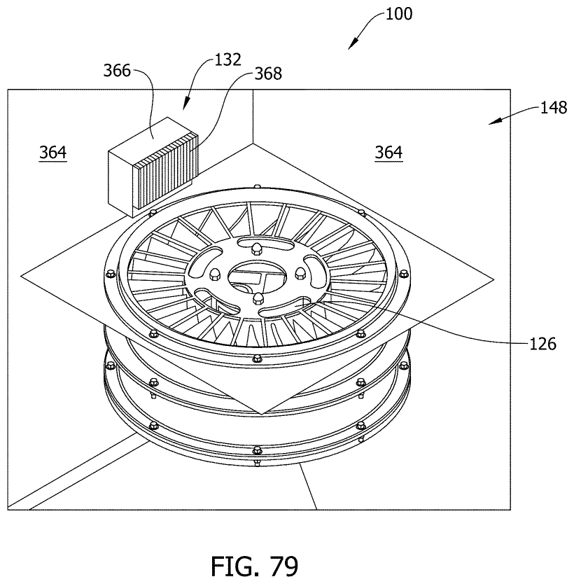

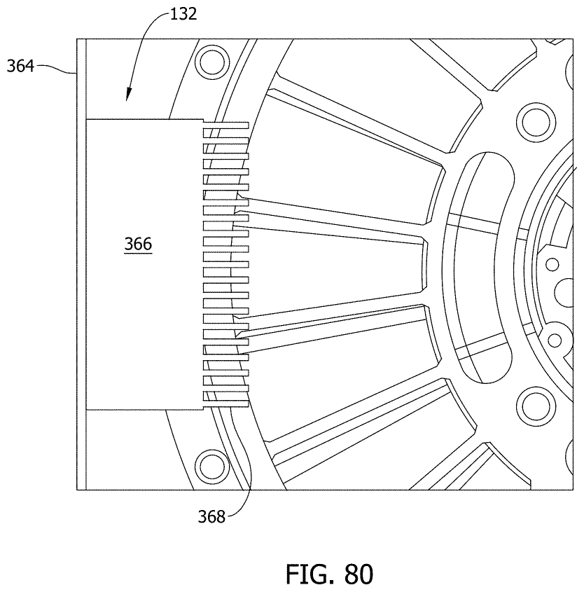

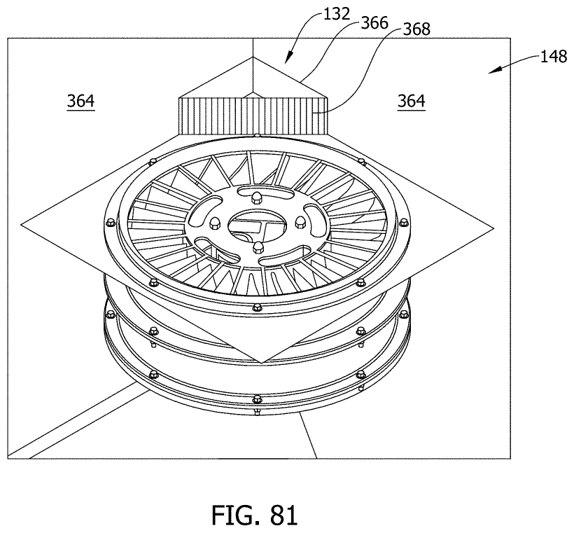

Referring to FIGS. 77-82, control assembly 132 of vaneaxial blower system 100 is located remotely from motor 126. Control assembly 132 may have any shape, including circular (as shown in FIG. 77), triangular (as shown in FIG. 81), or rectangular (as shown in FIG. 79). When located remotely from motor 126, control assembly may be mounted anywhere within or partially within air moving system 148 that enables vaneaxial blower system 100 to function as described herein and provides sufficient cooling for control operation. For example, referring to FIGS. 77-78, control assembly 132 may be mounted in a corner defined between adjacent air moving system walls 160 downstream from blower system inlet 134 or, as shown in FIGS. 79-81, centered on one side of mounting plate 162. Furthermore, the control 132 might be mounted such that only the control heatsink or cooling fins are within the unit while the rest of the control 132 resides external to the ducting with a cover over the electronics.

Referring to FIGS. 79-81, vaneaxial blower system 100 includes a control assembly 132, which is used to control operation of motor 126. In the illustrated embodiments, vaneaxial blower system 100 and control assembly 132 are mounted within an air moving system 148, including a plurality of air moving system walls 364 angled relative to each other. Control assembly 132 may have any shape that enables it to be mounted within air moving system 148.

As shown in FIGS. 79 and 80, control assembly 132 has a rectangular shape and is mounted to one of air moving system walls 364. Control assembly 132 includes a control housing 366 and a plurality of thermally conductive fins 368 extending therefrom. Thermally conductive fins 368 are oriented and sized to extend within the airflow stream discharged from stator 104. Thus, heat generated by control assembly 132 may be dissipated to the airflow stream by thermally conductive fins 368. In an alternative embodiment, referring to FIG. 81, control assembly 132 has a triangular shape and is positioned in a corner defined between adjoining air moving system walls 364.

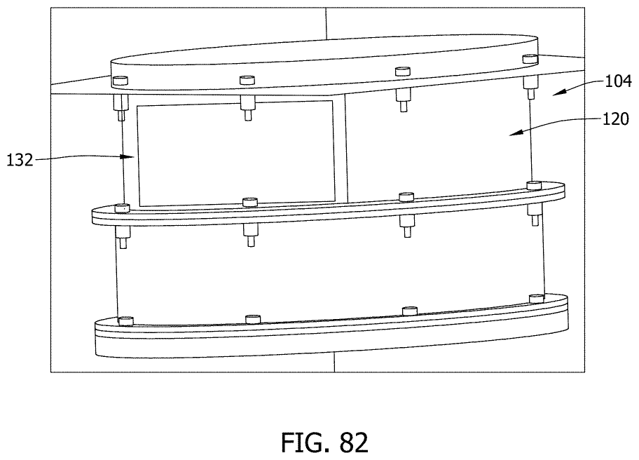

Referring to FIG. 82, in some embodiments, the control assembly 132 is mounted directly to stator shroud 120 to enable heat generated by control assembly to be dissipated to the airflow channeled through stator 104. In some embodiments, thermal grease may be added between control assembly 132 and stator shroud 120.

Other variations to the disclosed embodiments can be understood and effected by those skilled in the art in practicing the claimed invention, from the study of the drawings, the disclosure, and the appended claims. In the claims the word “comprising” does not exclude other elements or steps and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope of the claims.

While the invention has been illustrated and described in detail in the drawings and foregoing description, such illustration and description are to be considered illustrative or example and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A vaneaxial blower system having an axis of rotation, the vaneaxial blower system comprising:
a stator shroud having a stator inlet and a stator outlet, and stator blades extending from a stator hub, the stator blades having a leading edge and a trailing edge; wherein an angle beta is defined as an angle measured between a camber line between a first stator blade and a second stator blade of the stator blades and a horizontal tangential line that extends through respective leading edges of the first stator blade and second stator blade; wherein an angle theta is defined by a line extending from the respective leading edges to the respective trailing edges and the stator hub; and,
a rotor fan having a hub, a rotor inlet and a rotor outlet, the rotor outlet positioned against the stator inlet; the rotor fan further comprising rotor blades having a leading edge and a trailing edge; wherein system airflow enters the rotor inlet and exits from the stator outlet;
wherein at a span at the stator hub, the angle beta for the leading edge is in the range of −3 degrees to −43 degrees and the angle beta for the trailing edge is in the range of 11 degrees to −29 degrees, the angle theta for the leading edge is 8 degrees to −32 degrees and the angle theta for the trailing edge is in the range of −7 degrees to −47 degrees; and,
wherein at a span at the stator shroud, the angle beta for the leading edge is in the range of −27 degrees to −67 degrees and the angle beta for the trailing edge is in the range of −2 degrees to −42 degrees, the angle theta for the leading edge is 8 degrees to −32 degrees and the angle theta for the trailing edge is in the range of −7 degrees to −47 degrees.

2. The vaneaxial blower system of claim 1, wherein at a span half a distance from the stator hub to the stator shroud, the angle beta for the leading edge is in the range of −16 degrees to −56 degrees and the angle beta for the trailing edge is in the range of 6degrees to −34 degrees, the angle theta for the leading edge is 8 degrees to −32 degrees and the angle theta for the trailing edge is in the range of −7 degrees to −47 degrees.

3. The vaneaxial blower system of claim 1 further comprising a rotor housing extending around the rotor fan, the rotor housing having an inlet and an outlet, the outlet of the rotor housing in contact with the stator inlet.

4. The vaneaxial blower system of claim 3, wherein the rotor housing and the stator shroud define a unitary body.

5. The vaneaxial blower system of claim 3, wherein a rotor shroud integral to the rotor blades further includes a flared inlet section.

6. The vaneaxial blower system of claim 5 further comprising a lip section positioned against the inlet of the rotor shroud, wherein the lip section and the flared inlet section define a recirculation inhibitor restricting airflow recirculation through a recirculation chamber between the rotor shroud and the rotor housing.

7. The vaneaxial blower system of claim 5, wherein the rotor shroud further includes a flared inlet section extending from the first rim.

8. The vaneaxial blower system of claim 7, wherein the flared inlet section has a shape selected from the group consisting of a curved cross-sectional shape that is convex relative to a centerline of vaneaxial blower system and an angled cross-sectional shape that is convex relative to the centerline.

9. A vaneaxial blower system having an axis of rotation, the vaneaxial blower system comprising:
a stator shroud having a stator inlet and a stator outlet, and stator blades extending from a stator hub, the stator blades having a leading edge and a trailing edge; and,
a rotor fan having a hub, a rotor inlet and a rotor outlet, the rotor outlet positioned against the stator inlet; the rotor fan further comprising rotor blades having a leading edge and a trailing edge; wherein system airflow enters the rotor inlet and exits from the stator outlet; wherein an angle beta is defined as an angle measured between a camber line between a first rotor blade and a second rotor blade of the rotor blades and a horizontal tangential line that extends through respective leading edges of the first rotor blade and second rotor blade; wherein an angle theta is defined by a line extending from the respective leading edges to the respective trailing edges and the hub of the rotor fan;
wherein at the rotor hub, the angle beta for the leading edge is in the range of 60 degrees to 100 degrees and the angle beta for the trailing edge is in the range of 20 degrees to 60 degrees, the angle theta for the leading edge is −43 degrees to −83 degrees and the angle theta for the trailing edge is in the range of −7 degrees to −47 degrees; and,
wherein at a span at the rotor hub, the angle beta for the leading edge is in the range of 57 degrees to 97 degrees and the angle beta for the trailing edge is in the range of 40 degrees to 80 degrees, the angle theta for the leading edge is −57 degrees to −97 degrees and the angle theta for the trailing edge is in the range of −25 degrees to −65 degrees.

10. The vaneaxial blower system of claim 9 further comprising a rotor housing extending around the rotor fan, the rotor housing having an inlet and an outlet, the outlet of the rotor housing in contact with the stator inlet.

11. The vaneaxial blower system of claim 10, wherein a rotor shroud integral to the rotor blades further includes a flared inlet section.

12. The vaneaxial blower system of claim 11 further comprising a lip section positioned against the inlet of the rotor shroud, wherein the lip section and the flared inlet section defining a recirculation inhibitor restricting airflow recirculation through a recirculation chamber between the rotor shroud and the rotor housing.

13. The vaneaxial blower system of claim 12. wherein the recirculation inhibitor includes a sealing member integral to rotor housing and extending radially towards rotor shroud.

14. The vaneaxial blower system of claim 9, wherein at a span half a distance from the rotor hub to an end of the rotor blades, the angle beta for the leading edge is in the range of 50 degrees to 90 degrees and the angle beta for the trailing edge is in the range of 35 degrees to 75 degrees, the angle theta for the leading edge is −48 degrees to −88 degrees and the angle theta for the trailing edge is in the range of −14 degrees to −54 degrees;

15. A vaneaxial blower system having an axis of rotation, the vaneaxial blower system comprising:
a stator shroud having a stator inlet and a stator outlet, and stator blades extending from a stator hub, the stator blades having a leading edge and a trailing edge; wherein an angle beta is defined as an angle measured between a camber line between a first stator blade and a second stator blade of the of the stator blades and a horizontal tangential line that extends through respective leading edges of the first stator blade and second stator blade; wherein an angle theta is defined by a line extending from the respective leading edges to the respective trailing edges and the stator hub; and,
a rotor fan having a hub, a rotor inlet and a rotor outlet, the rotor outlet positioned against the stator inlet; the rotor fan further comprising rotor blades having a leading edge and a trailing edge; wherein system airflow enters the rotor inlet and exits from the stator outlet; wherein an angle beta is defined as an angle measured between a camber line between a first rotor blade and a second rotor blade of the of the rotor blades and a horizontal tangential line that extends through respective leading edges of the first rotor blade and second rotor blade; wherein an angle theta is defined by a line extending from the respective leading edges to the respective trailing edges and the hub of the rotor fan;
wherein at a span at the stator hub, the angle beta for the leading edge is in the range of −3 degrees to −43 degrees and the angle beta for the trailing edge is in the range of 11degrees to −29 degrees, the angle theta for the leading edge is 8 degrees to −32 degrees and the angle theta for the trailing edge is in the range of −7 degrees to −47 degrees; and, wherein at a span at the stator shroud, the angle beta for the leading edge is in the range of −27 degrees to −67 degrees and the angle beta for the trailing edge is in the range of −2 degrees to −42 degrees, the angle theta for the leading edge is 8 degrees to −32 degrees and the angle theta for the trailing edge is in the range of −7 degrees to −47 degrees;
wherein at a span at the rotor hub, the angle beta for the leading edge is in the range of 60 degrees to 100 degrees and the angle beta for the trailing edge is in the range of 20 degrees to 60 degrees, the angle theta for the leading edge is −43 degrees to −83 degrees and the angle theta for the trailing edge is in the range of −7 degrees to −47 degrees; and, wherein at the rotor hub, the angle beta for the leading edge is in the range of 57 degrees to 97 degrees and the angle beta for the trailing edge is in the range of 40 degrees to 80 degrees, the angle theta for the leading edge is −57 degrees to −97 degrees and the angle theta for the trailing edge is in the range of −25 degrees to −65 degrees.

16. The vaneaxial blower system of claim 15 further comprising a rotor housing extending around the rotor fan, the rotor housing having an inlet and an outlet, the outlet of the rotor housing in contact with the stator inlet.

17. The vaneaxial blower system of claim 16, wherein a rotor shroud integral to the rotor blades further includes a flared inlet section.

18. The vaneaxial blower system of claim 17 further comprising a lip section positioned against the inlet of the rotor shroud, wherein the lip section and the flared inlet section define a recirculation inhibitor restricting airflow recirculation through a recirculation chamber between the rotor shroud the and rotor housing.

19. The vaneaxial blower system of claim 18, wherein the recirculation inhibitor includes a sealing member integral to rotor housing and extending radially towards rotor shroud.

20. The vaneaxial blower system of claim 14, wherein at a span half a distance from the stator hub to the stator shroud, the angle beta for the leading edge is in the range of −16 degrees to −56 degrees and the angle beta for the trailing edge is in the range of 6 degrees to −34 degrees, the angle theta for the leading edge is 8 degrees to −32 degrees and the angle theta for the trailing edge is in the range of −7 degrees to −47 degrees; and, wherein at a span half a distance from the rotor hub to an end of the rotor blades, the angle beta for the leading edge is in the range of 50 degrees to 90 degrees and the angle beta for the trailing edge is in the range of 35 degrees to 75 degrees, the angle theta for the leading edge is −48 degrees to −88 degrees and the angle theta for the trailing edge is in the range of −14 degrees to −54 degrees.
